(19) United States
(12) Patent Application Publication
(10) Pub. No.: US 2008/0244135 A1
(43) Pub. Date: Oct. 2, 2008

(54) Memory Controller and Method For Controlling Access to a Memory, as Well as System Comprising a Memory Controller

(75) Inventors: Kjell Benny Akesson, Veldhoven (NL); Andrei Radulescu, Eindhoven (NL); Kees Gerard Willem Goossens, Eindhoven (NL); Frits Anthonie Steenhof, Eindhoven (NL)

Correspondence Address: NXP, B.V.;NXP INTELLECTUAL PROPERTY DEPARTMENT, M/S41-SJ, 1109 MCKAY DRIVE, SAN JOSE, CA, 95131, US

(73) Assignee: NXP B.V., Eindhoven (NL)

(21) Appl. No.: 11/913,660

(22) PCT Filed: May 1, 2006
(86) PCT No.: PCT/IB06/51359

§ 371 Date: May 27, 2008

(30) Foreign Application Priority Data
May 4, 2005 (EP) 05103760.4
Nov. 23, 2005 (EP) 05111152.4

(51) Int. Cl. G06F 13/36

(52) U.S. Cl. 710/241

(57) ABSTRACT

In the method for controlling access of a plurality of requestors to a shared memory, the following steps are repeated for successive time-windows: receiving access requests from various requestors (S1), determining a type of access requested by the requests, comparing the requested access type with an access type authorized for a respective time-window according to a back-end schedule, generating a first selection of the incoming requests which have the prescribed access type for the relevant time-window, dynamically selecting one of the requests from the first selection.

The present invention relates to a memory controller.

The present invention further relates to a method for arbitrating access to a memory

The present invention further relates to a system comprising a memory controller.

Current data processing systems can have a large number of clients, hereafter referred to as requesters, having diverse, and possibly conflicting, requirements. More in particular a requestor is defined in the sequel as a logical entity that requires access to a memory. Random access memory, RAM, is a fundamental component in computer systems. It is used as intermediate storage for the processing units in the system, such as processors. There are several types of RAM targeting different requirements on bandwidth, power consumption, and manufacturing cost. The two most common types of RAM are SRAM and DRAM. Static RAM, SRAM, was introduced in 1970 and offers high bandwidth and low access time. SRAM is often used for caches in the higher levels of the memory hierarchy to boost performance. The drawback of SRAM is cost since six transistors are needed for every bit in the memory array. DRAM is considerably cheaper than SRAM, as it needs only one transistor and a capacitor per bit, but has a lower speed. In the past ten years the DRAM design has been significantly improved. A clock signal has been added to the previously asynchronous DRAM interface to reduce synchronization overhead with the memory controller during burst transfers. This kind of memory is called synchronous DRAM, or SDRAM for short. Double-data rate (DDR) SDRAM features a significantly higher bandwidth as it transfers data on both the rising and the falling edge of the clock effectively doubling the bandwidth. The second generation of these DDR memories, called DDR2, is very similar in design but scales to higher clock frequencies and peak bandwidth.

A requestor may be further specified by one or more of the following parameters: an access direction d (read/write), a minimum requested data bandwidth (w), a maximum request size in words (σword), a maximum latency (l), and a priority level (c).

In this connection a CPU is considered as a combination of a first requestor that requires read access, and a second requestor that requires writes access to the memory. A dynamic memory could be considered as a requestor itself, as it requires time for refresh of its contents. Other memories may likewise request time for a periodical error correction of their contents. Some of the requestors can have real-time requirements while others do not. Different kinds of traffic can be identified, having different requirements with respect to bandwidth, latency and jitter. Non real-time traffic, such as memory requests from a cache miss by a CPU or a DSP, is irregular since these requests can occur at virtually anytime and once served involve the transmission of a complete cache line. The processor will be stalled while waiting for the cache line to be returned from the memory and thus the lowest possible latency is required to prevent wasting processing power. This kind of traffic requires good average throughput and a low average latency but puts hardly restrictions on the worst-case as long as it occurs infrequently.

There are two types of real-time applications: soft and hard. A soft real-time application does not have an absolute service contract. It follows that the guarantees can occasionally be violated and hence can be statistical in nature. Embedded systems are more concerned with hard real-time requirements since they are more application specific and can be tailored to always meet their specification.

Consider a set-top box doing audio/video decoding. The requests and responses have predictable sizes and repeats periodically. This type of traffic requires a guaranteed minimum bandwidth to get the data at its destination. Low latency is favorable in this kind of system but it is more important that the latency is constant. Variations in latency, commonly referred to as jitter, causes problems since buffers are required in the receiver to prevent underflows causing stuttering playback. For this reason this kind of system requires low bounded jitter.

Control systems are used to monitor and control potentially critical systems. Consider a control system in a nuclear power plant. Sensor input has to be delivered to the regulator before it is too late in order to prevent a potentially hazardous situation. This traffic requires guaranteed minimum bandwidth and a low worst-case latency but is jitter tolerant.

The CPU, set-top box and control system described above shows the span of requirements and good memory solutions can be designed for any of these systems. Difficulties arise when all of these traffic types have to be served by the same system, which is particularly the case in complex contemporary embedded systems were all traffic types are present simultaneously. Such a system requires a flexible memory solution to address the diversity. Bandwidth can be specified gross or net, which further complicates the requirements. Gross bandwidth is a peak bandwidth measure that does not take memory efficiency into account. A gross bandwidth guarantee translates into guaranteeing the requesters a number of memory clock cycles, which is what most memory controllers do. If the traffic is not well behaved or if the memory controller is inefficient the net bandwidth is only a fraction of the gross bandwidth. Net bandwidth, is what the applications request in their specifications and corresponds to the actual data rate. The difficulty in providing a net bandwidth guarantee lies in that details of how the traffic accesses memory have to be well known.

Two types of memory controllers can be discerned, static and dynamic. These types of controllers have very different properties. A static memory controller follows a hard-wired schedule to allocate memory bandwidth to requestors. The major benefit of static memory controllers is predictability; they offer guaranteed minimal bandwidth, maximal latency and bounds on jitter, which is very important in real-time systems. It is well known how the schedule will access memory since it is pre-calculated. This makes it is possible for static memory controllers to offer net bandwidth guarantees.

Static memory controllers however, do not scale very well since the schedule has to be recomputed if additional requestors are added to the system. The difficulties of calculating a schedule also grow with an increasing number of requestors. A static memory controller is suitable in a system with predictable requestors but cannot provide low latency to intermittent requestors. Due to lacking flexibility a dynamic workload is not handled well and results in significant waste.

Dynamic memory controllers make decisions at runtime and can adapt their behavior to the nature of the traffic. This makes them very flexible and allows them to achieve low average latency and high average throughput, even with a dynamic workload. The offered requests are buffered and one or more levels of arbitration decide which one to serve. The arbitration can be simple with static priorities or may involve complex credit-based schemes with multiple traffic classes. While these arbiters can be made memory efficient it comes at a price. Complex arbiters are slow, require a lot of chip area and are difficult to predict. The unpredictability of dynamic memory controllers makes it very difficult to offer hard real-time guarantees and calculate useful worst-case latency bounds. How memory is accessed depends to a very large degree on the offered traffic. However, the actual available number of clock cycles available for memory access depends on various factors, such as the frequency with which the access direction changes from read to write, for a DRAM the number of times a new row is activated etc. Consequently these controllers cannot offer guarantees on net bandwidth by construction. A way to derive such a guarantee is to try to simulate the worst-case traffic and over-allocate the gross cycles to get a safety margin. The amount of over-allocation can be severe if the worst-case traffic is known and it can be discussed if the derived guarantee is good enough for a hard real-time system.

It is a purpose of the invention to provide a memory controller and a method for scheduling access to a memory that can guarantee a minimum bound for the bandwidth and an upper bound for the latency, while it is sufficiently flexible.

This purpose is achieved by a method according to the invention as claimed in claim 1.

This purpose is achieved by a memory controller according to the invention as claimed in claim 2.

In the memory controller and the method according to the invention a predetermined back end schedule similar to that of a static memory controller design, defines how memory is accessed. As the access pattern to the memory is fixed, also the total amount of net bandwidth available to the requestors is fixed. The net bandwidth in the schedule is allocated to the requesters as credits by an allocation scheme offering hard real-time guarantees on net bandwidth. Contrary to the procedure in a static memory controller, however, access to the memory is provided by a dynamic front-end scheduler that increases the flexibility of the design yet provides a theoretical worst-case latency bound. Dependent on the trade-off made for fairness, jitter bounds and buffering a selection can be made from various front-end schedulers, such as Round Robin, provided that the arbitration policy of the front end-scheduler complies with the fixed back end schedule.

In the computation of the back end schedule predetermined or long-term requirements of the memory requesters in terms of bandwidth are taken into account. Then the total requirements in terms of reads and writes for each of the banks are accumulated, as well as other requirements, e.g. refresh requirements, in case the memory is a DRAM, or regular error correction requirements in case of a flash memory for example. In this stage the source of the requests is left out of consideration, only the total bandwidth for each category of memory access within the time-window selected for scheduling is relevant. Having accumulated the bandwidth requested for each of the access categories it is preferably determined whether the sum of the bandwidths requested is less than the net available bandwidth. If this is not the case, a proper scheduling cannot be found, and another hardware configuration has to be considered, or it has to be accepted that not all the requirements can be met.

The first stage of the method may be executed statically. I.e. the back end schedule may be defined together with the design of the system and may be stored in a ROM for example. The back end schedule may be based on predetermined properties and requirements of the memory requesters, e.g. the required bounds for latency and bandwidth as well as the behavior of the requestor in terms of number of read and write requests, etc. The total requirements in terms of reads and writes for each of the banks are accumulated and it is determined in which order these accesses can take place most efficiently, ignoring the source of the request in this stage.

Alternatively the memory controller may have a facility for allowing a user to define the back end schedule.

Alternatively the first stage of the method according to the invention may be performed dynamically. For example the scheduler may update the back end schedule at regular time intervals to adapt it to an observed behavior of the requestors.

Preferably the schedule is a basic access pattern that is periodically repeated. Such a schedule can be computed relatively easily.

These and other aspects are described in more detail with reference to the drawing. Therein:

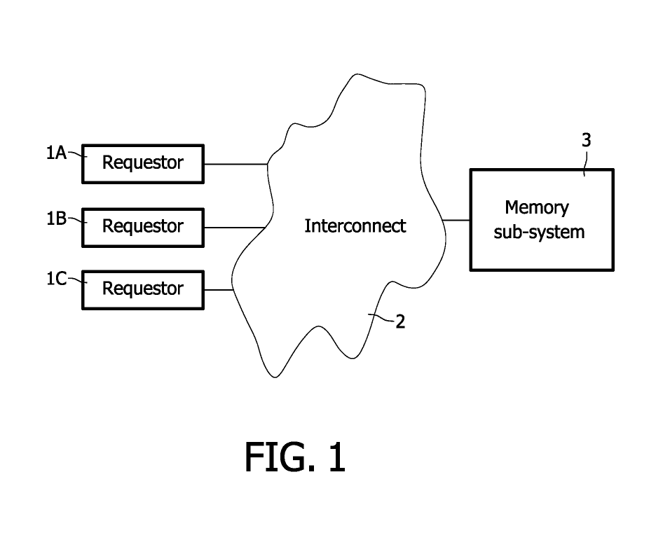

FIG. 1 schematically shows a system comprising various requestors that are connected to a memory sub-system through an interconnection facility,

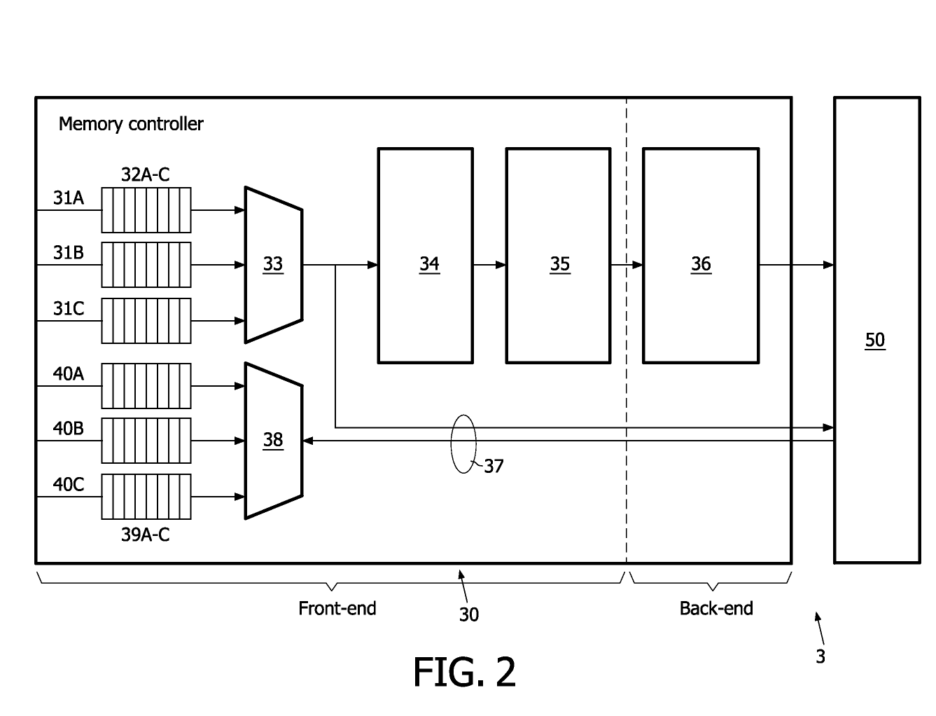

FIG. 2 shows in more detail the memory sub-subsystem, with a memory controller in which the present invention is applicable,

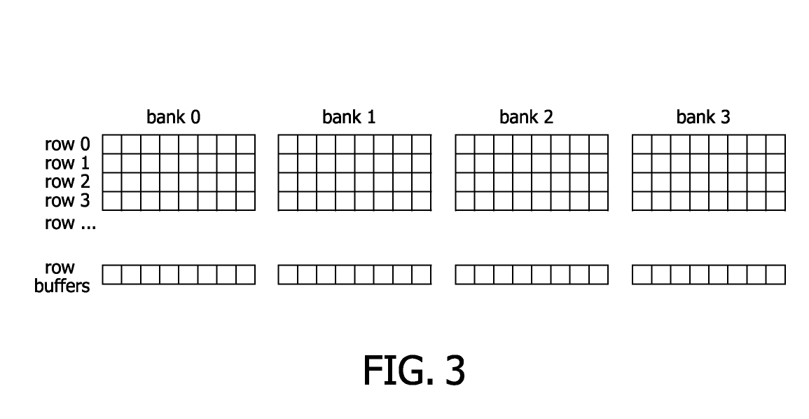

FIG. 3 shows a memory layout,

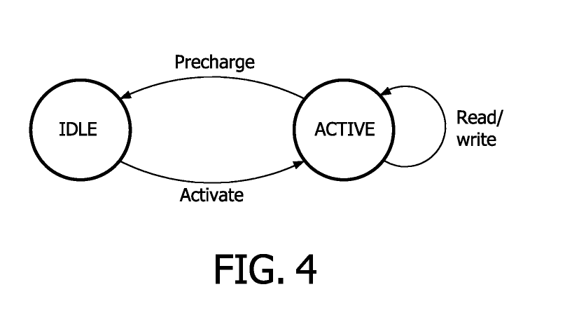

FIG. 4 shows a simplified DDR state diagram,

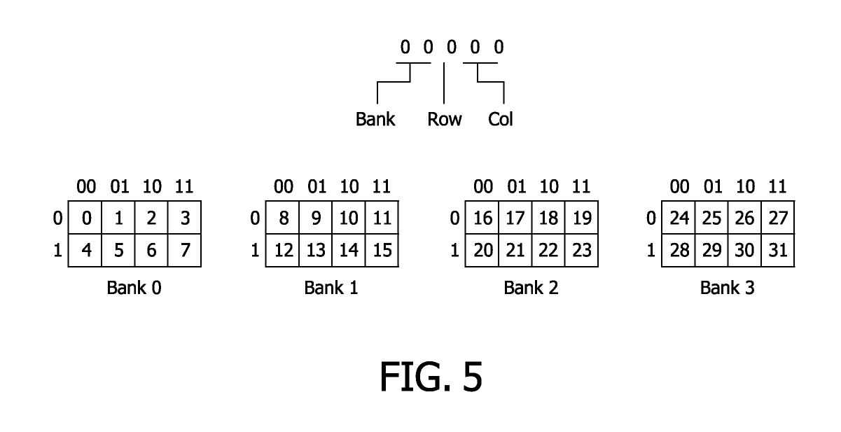

FIG. 5 shows a first example of a memory map,

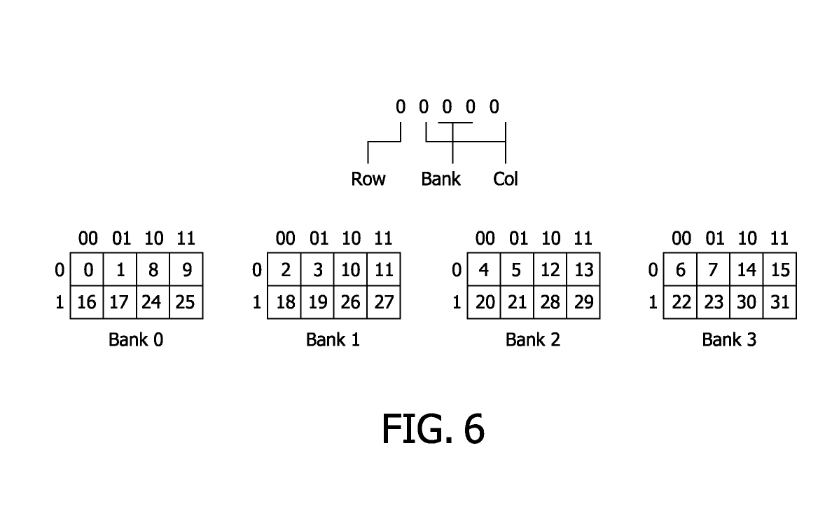

FIG. 6 shows a second example of a memory map,

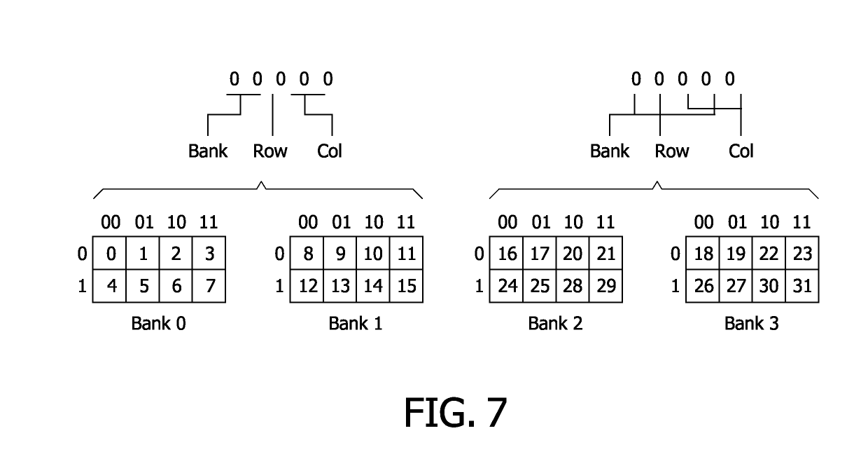

FIG. 7 shows a third example of a memory map,

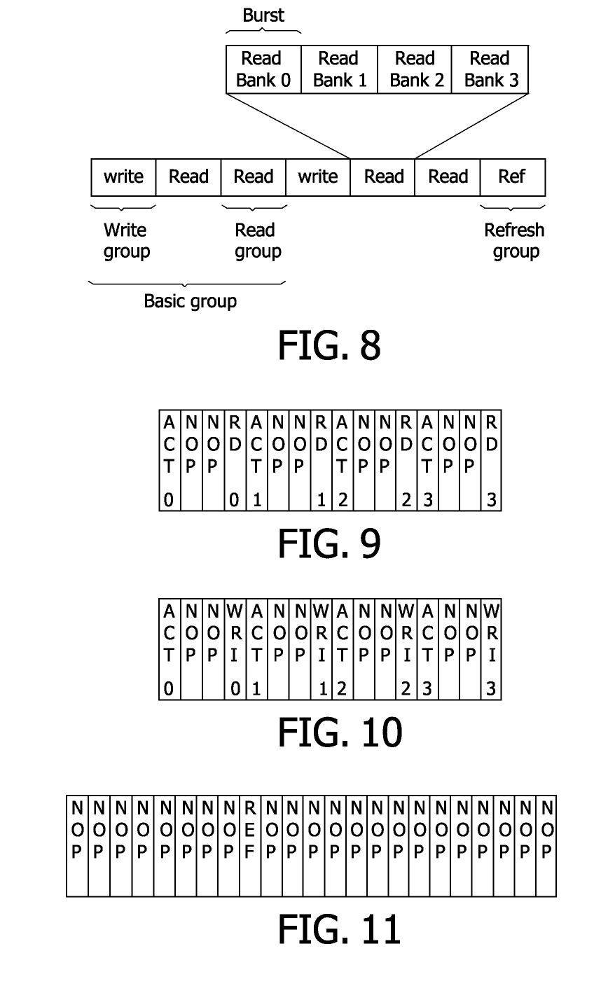

FIG. 8 schematically shows the read, write and refresh groups to be applied in a back end schedule,

FIG. 9 schematically shows a basic read group,

FIG. 10 schematically shows a basic write group,

FIG. 11 schematically shows a basic refresh group,

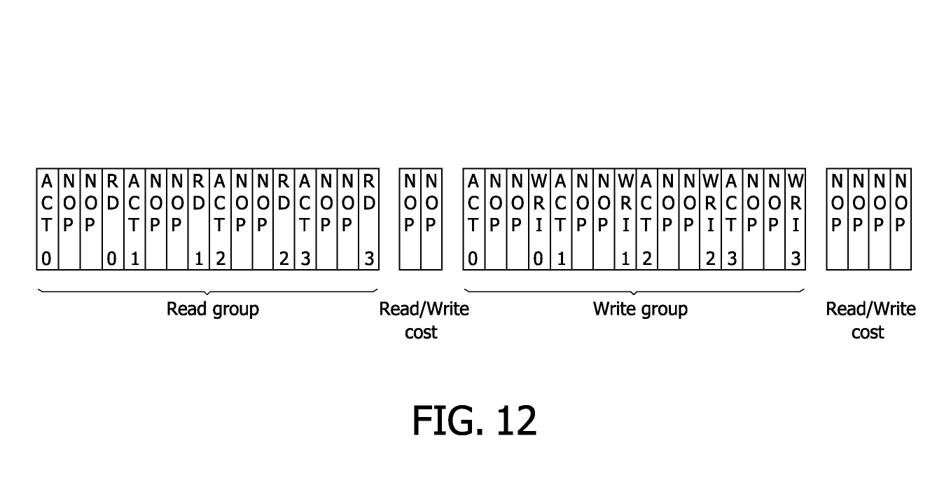

FIG. 12 schematically illustrates the costs incurred in switching between a read and a write group,

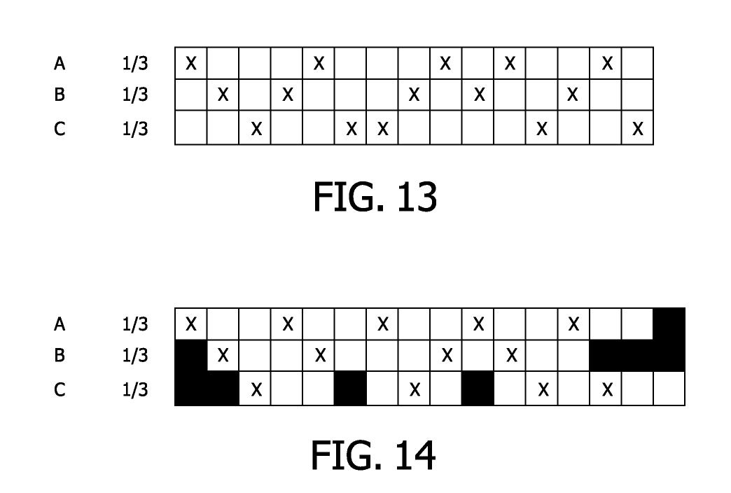

FIG. 13 shows an example of a schedule wherein the memory bursts are scheduled in an arbitrary order,

FIG. 14 shows an example of a schedule wherein the requesters have sliding allocation windows,

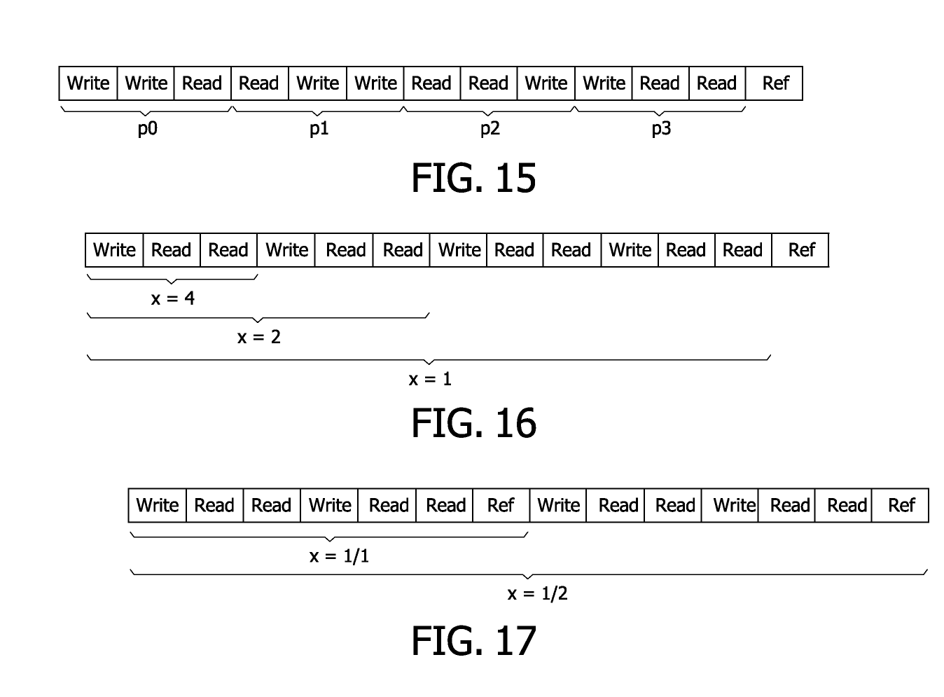

FIG. 15 shows a sequence of four service periods with different read/write mixes,

FIG. 16 shows a schedule where the service period is executed an integral number of times during one revolution of the back end schedule,

FIG. 17 shows a schedule wherein a service period is executed in an integral number of revolutions of the back end schedule,

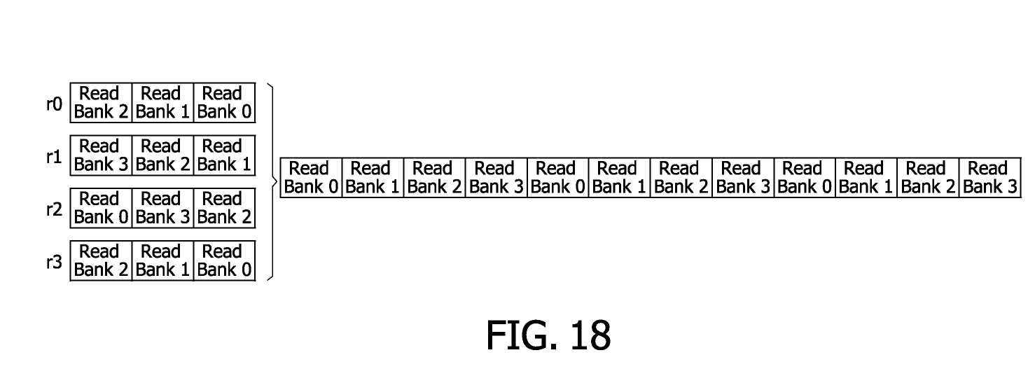

FIG. 18 shows a schedule for an interleaved memory map,

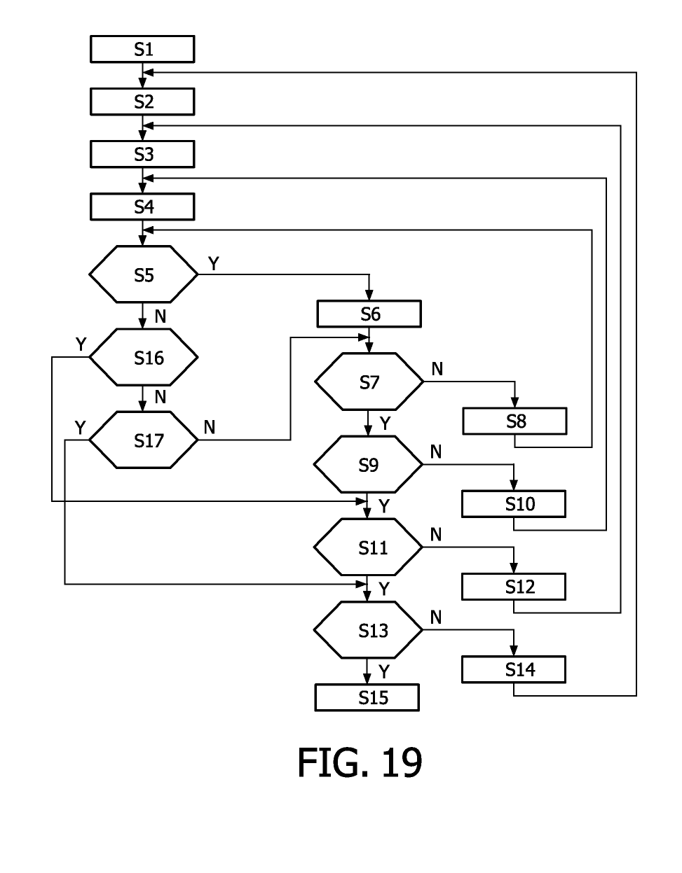

FIG. 19 shows a method for calculating a back-end schedule.

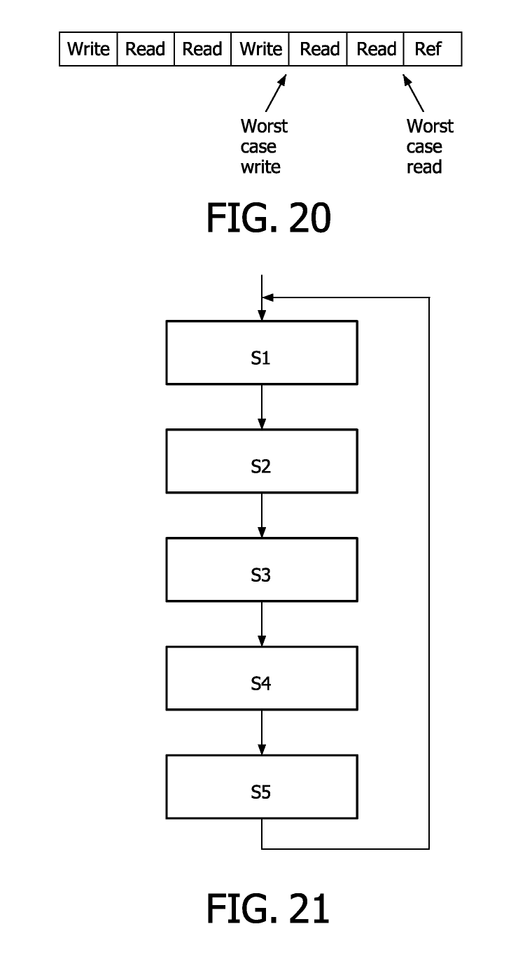

FIG. 20 shows worst-case positions in the back-end schedule for reads and writes,

FIG. 21 schematically shows a front-end scheduler according to the invention,

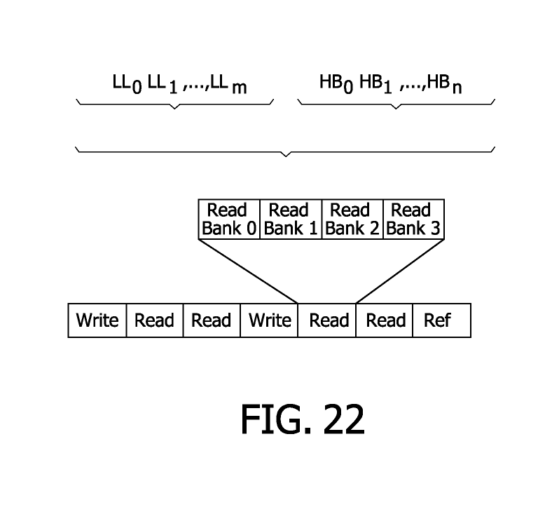

FIG. 22 schematically shows the order in which various types of requestors are served,

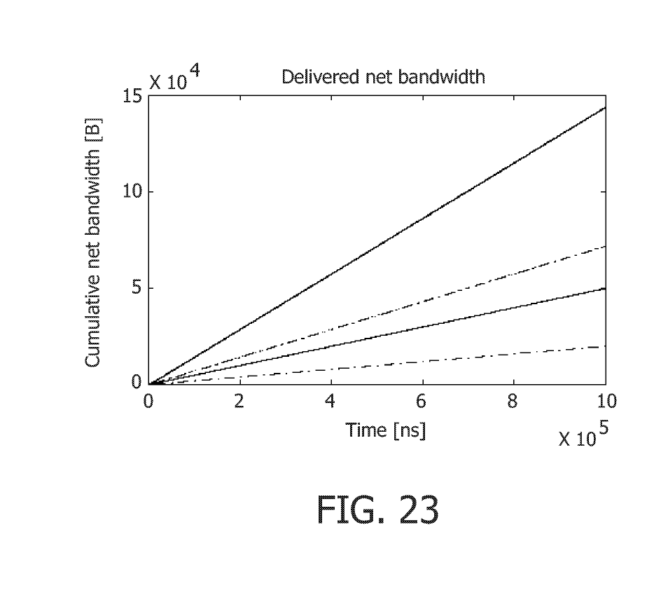

FIG. 23 shows the cumulative bandwidth supplied to the requesters in a memory-aware system,

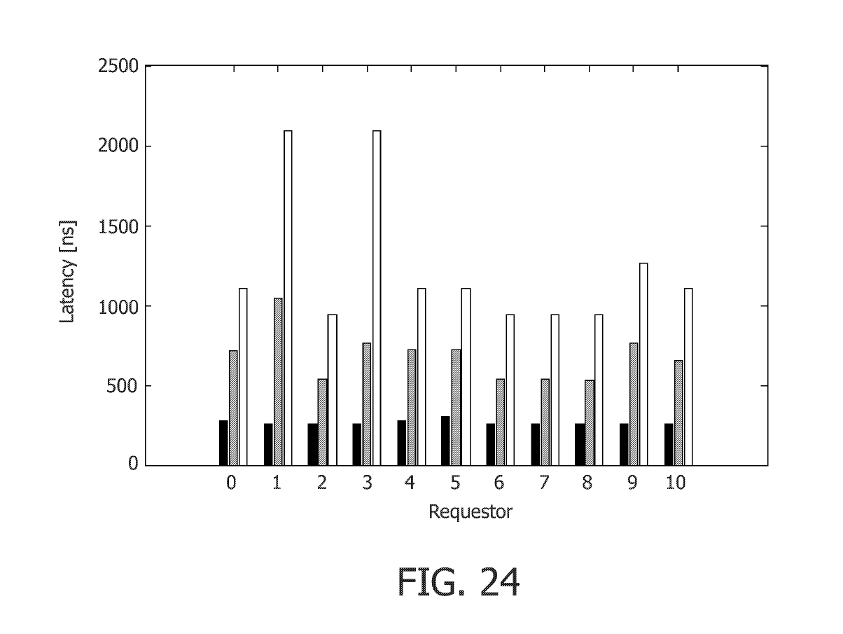

FIG. 24 shows key figures indicative for the latency experienced by the requestors in a first simulated embodiment of the invention,

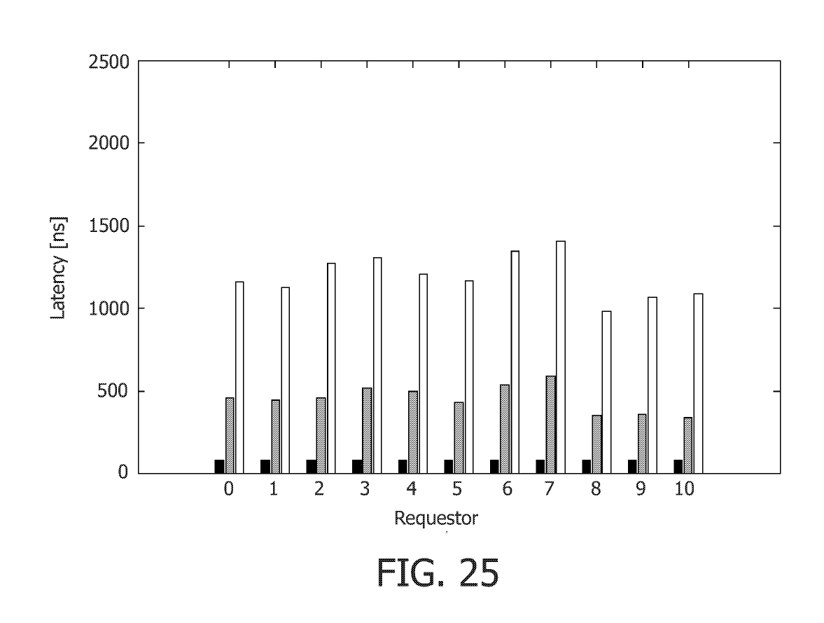

FIG. 25 shows key figures for the latencies experienced by the requesters in a further embodiment,

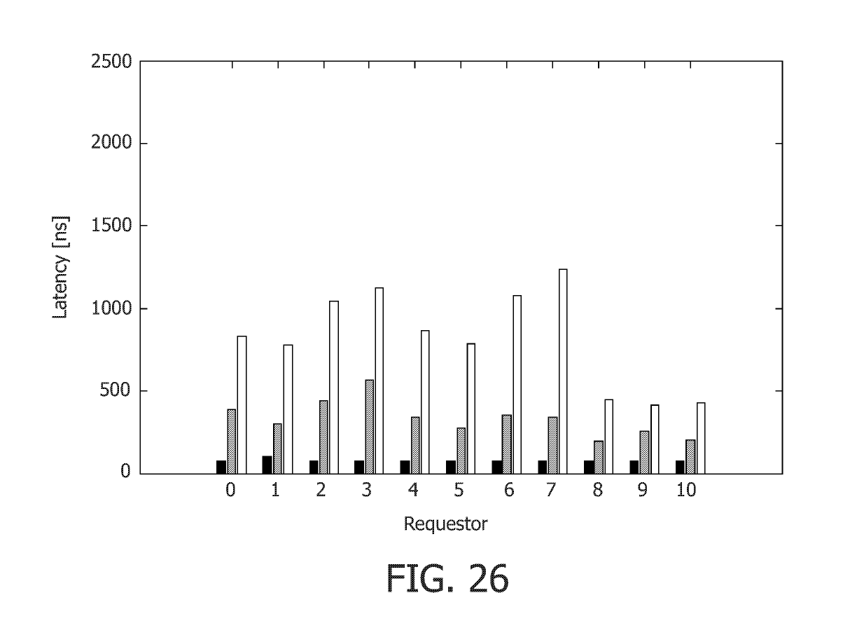

FIG. 26 shows key figures for the latencies experienced by the requesters in a still further embodiment.

The more detailed embodiments described herein to further clarify the invention are in particular relevant for a synchronous DRAM. The skilled person however, will readily understand that the invention is also useful in another systems using a memory where the efficiency of the memory depends on the access pattern to the memory

The system considered consists of one or more requestors 1A,1B,1C. The requestors 1A,1B,1C are connected to the memory sub-system 3 through an interconnection facility 2, such as direct wires, a bus or a network-on-chip. This is illustrated in FIG. 1.

The memory sub-subsystem 3 comprises the memory controller 30 and the memory 50, as shown in FIG. 2. The memory controller 30 comprises a plurality of channel buffers as is schematically illustrated therein. Every requestor 1A, . . . , 1C is coupled with a request buffer 32A,32B,32C via an input 31A, 31B, 31C and to a response buffer 39A,39B, 39C via an output 40A, 40B, 40C. These buffers provide for a clock domain crossing so that the memory controller may operate at a different frequency than the interconnection facility. It will be readily understood by the skilled person that the memory controller does not need physically separate inputs and physically separate outputs, but that for example a bus may be shared by the requestors 1A, 1B, 1C. Likewise a buffer may be shared, having separate address ranges for the requests or responses related to the various requestors. A requestor communicates with the memory 50 through a connection. A connection is a bi-directional message stream with request and response channels that connect a requestor to the corresponding buffers in the memory controller. The traffic characteristics and the desired quality-of-service level of a requestor are specified in use-case specifications. The admittance control of the memory controller accepts the service contract of a requestor provided that there are enough resources available to honor it. It then guarantees that the requirements are fulfilled as long as the requestor behaves according to the specification. A first part of a bi-directional data path 37 to the memory 50 is coupled via a selection unit 33 to the input buffers 32A, . . . ,32C. The arbitrator 35 controls the selection unit. An output of the memory 50 is coupled via a second part of the bi-directional data path 37 to a deselection unit 38. The deselection unit 38 is controlled by the arbitrator 35 to selectively provide the data received via the second half of the bi-directional data path to one of the output buffers.

In the following it is supposed that a requestor is allowed to read or write, but not both. This separation is not uncommon as can be seen in [8]. Requestors communicate with the memory by sending requests. A request is sent on the request channel and is stored in the designated request buffer until it is serviced by the memory controller. In case of a read request the response data is stored in the response buffer until it is returned on the response channel. The request buffer may contain fields for command data (read or write request), a memory address, and the length of the request and, in case of a write command, write data. Requests in the request buffer are served in a first-come-first-served (FCFS) order by the memory controller, which thus provides sequential consistency within every connection, assuming that this is supported by the interconnection facility. No synchronization or dependency tracking is provided between different connections and must be supplied elsewhere.

Considering this architecture of the channel buffer model it can be seen that the latency of a request in the memory sub-system can be defined the sum of the four components: request queue latency, service latency, memory latency, and response queue latency. For the purpose of the present application only the service latency will be taken into consideration as this feature reflects how the memory controller schedules the memory. The service latency however, is independent of the interconnection facility and the timings of a particular memory device. More in particular the service latency is measured from the moment a request is in the head of the request queue until the last word has left the queue.

Modem DRAMs have a three dimensional layout, the three dimensions being banks, rows and columns. A bank is similar to a matrix in the sense that it stores a number of word-sized elements in rows and columns. The described memory layout is depicted in FIG. 3.

On a DRAM access, the address is decoded into bank, row and column addresses.

A bank has two states, idle and active. A simplified DDR state diagram is shown in

FIG. 4. The bank is activated from the idle state by an activate command that loads the requested row onto the sense amplifiers, also known as the row buffer. Every bank has a row buffer, which is used to cache the most recently used row. Once the bank has been activated, column accesses such as read and write commands can be issued to the columns in the row buffer. A precharge command is issued to return the bank to the idle state. This stores the row in the buffer back into the memory array. A row is also referred to as a page that can be opened or closed depending on whether it is present in the row buffer or not. A memory access to a closed page is referred to as a page fault.

Reads and writes are done in bursts of 4 or 8 words. An opened page is divided into uniquely addressable boundary segments of the burst size that is programmed in the memory on initialization. This limits the set of possible start addresses for a burst.

Many systems experience spatial locality in memory accesses meaning that subsequent memory accesses often target memory addresses in close proximity of each other. It is therefore common for several read and write commands to target an already activated row since a typical row size on a DDR2 memory device is 1 KB.

In order not to loose data as a result of the previously described leakage, all the rows in the DRAM have to be refreshed regularly. This is done by issuing a refresh command. Each refresh command achieves that a memory row is refreshed. The refresh command needs more time on larger devices causing them to spend more time refreshing than smaller ones.

Before the refresh command is issued all banks have to be precharged. The SDRAM commands discussed are summarized in Table 1

TABLE 1
Some SDRAM commands.

| SDRAM | |
|---|---|
| command | Description |
| No operation | Ignore all inputs. |
| (NOP) | |
| Activate (ACT) | Open an active row in a particular |
| | bank |
| Read (RD) | Initiate a read burst to an active row |
| Write (WR) | Initiate a write burst to an active row |
| Precharge (PRE) | Close an active row in a particular |
| | bank |
| Refresh (REF) | Start a refresh operation |

By way of example a 256 Mb1 (32M×8) DDR2-400 SDRAM chip is considered as described in the DDR2 reference specification [9]. The SDRAM chip considered has a total number of 4 banks with 8192 rows each and 1024 columns per row. This means that 2 bits in the physical address are required for the bank number, 13 for the row number and 10 for the columns. The page size is 1 KB.

These chips have a word width of 8 bits but several chips are usually combined to create memories with larger word width. How the chips are combined on a memory module is referred to as the memory configuration. For instance, when four of these chips are put in parallel the memory module has a capacity of 256 Mb*4=128 MB and a word width of 32 bits. This particular memory runs at a clock frequency of 200 MHz, which for this particular configuration, results in a peak bandwidth of 200*2*32/8=1600 MB/s.

A command is always issued during one clock cycle but the memories have very tight timing constraints defining the required delay between different commands. The timings are found in the specification. The most important ones are summarized in Table 2

TABLE 2
Some timing parameters for DDR2-400 256 Mb

| | Time | |
|---|---|---|
| Parameter | (ns) | Description |
| tCK | 5 | Clock cycle time |
| tRAS | 45 | Activate to precharge command delay |
| tRC | 60 | Activate to activate command delay (same |
| | | bank) |
| tRCD | 15 | Activate to read or write delay |
| tRFC | 75 | Refresh to activate command delay |
| tRP | 15 | Precharge to activate command delay |
| tRRD | 7.5 | Activate to activate command delay (different |
| | | banks) |
| tREFI | 7800 | Average refresh to refresh command delay |
| tWR | 15 | Write recovery time |

A major benefit of a multi-bank architecture is that commands to different banks can be pipelined. While data is being transferred to or from a bank, the other banks can be precharged and activated with another row for a later request. This process, denoted as bank preparation can save a significant amount of time and sometimes completely hide the precharge and activate delays.

Embedded systems of today have high requirements when it comes to memory efficiency. This is natural since inefficient memory use means that faster memories have to be used, which are more expensive and consume more power. Memory efficiency e, is defined herein as the fraction between the amount of clock cycles during which data is transferred, S0, and the total number of clock cycles, S. Hence

e=S0/S (1)

Various factors contribute in causing data not to be transferred during every cycle. These factors are referred to as sources of inefficiency. The most important ones are refresh efficiency, data efficiency, bank conflict efficiency, read/write efficiency and command conflict efficiency. The relative contribution of these factors depends on the type of memory used. For dynamic memories the regular refreshing is a source of inefficiency. The time needed for refreshing depends on the state of the memory since all the banks have to be precharged before the refresh command is issued. The specification states that this has to be done on average once every t_{REFI}, which is 7800 ns for all DDR2 devices. The average refresh interval allows the refresh command to be postponed but not left out.

Refresh can be postponed up to a maximum of 9*t_{REFI}, when eight successive refresh commands must be issued. Postponing refresh commands is useful when scheduling

DRAM commands and helps amortizing the cost of precharging all banks. Refresh efficiency is relatively easy to quantify since the average refresh interval, clock cycle time and refresh time is derived from the specification of the memory device. Furthermore the refresh efficiency is traffic independent. The worst-case time needed to precharge all banks on DDR2-400 is ten cycles. This happens in the event that a bank is activated a cycle before the decision to refresh was taken. The refresh efficiency, e_{refresh}, of a memory device is calculated as shown in Equation 2, where n is the number of consecutive refresh commands and tₚ all is the time needed to precharge all banks. The timings must be converted to clock cycles in order for an accurate equation.

$$\begin{matrix}{e}_{refresh} = 1 - \frac{1}{{t}_{REFI} \cdot n} \cdot ( {t}_{RFC} \cdot n + {t}_{p\_all} ) ; & n ∈ [ 1 … 8 ]\end{matrix} \qquad ( 2 )$$

For the DDR2-400 described above the refresh efficiency is almost negligible, around 98.7% for a single refresh command. The refresh efficiency becomes more significant with larger and faster devices. For a 4 Gb DDR2-800 device the refresh efficiency drops down to 91.3%. There is, however, not much to do to reduce the impact of refreshes except trying to schedule them when the memory is idle.

Bursts cannot start on an arbitrary word since memory is divided into segments of the programmed burst size. As a consequence when requesting a memory access for unaligned data the segments comprising said unaligned data have to be written or read in its entirety. This reduces the total amount of desired data that is transmitted. The efficiency loss grows with smaller requests and bigger burst sizes. This problem is usually not solved by memory controllers since the minimum burst size is inherent to the memory device and the data alignment is a software issue.

When a burst targets a column that is not in an opened page, the bank has to be precharged and activated to open the requested page. As shown in Table 2 there is a minimum delay between consecutive activate commands to a bank resulting in a potentially severe penalty if consecutive read or write commands try to access different pages in the same bank. The impact of this is dependent on the traffic, timings of the target memory and on the memory mapping used.

This problem can be solved by reordering bursts or requests. Intelligent general-purpose memory controllers are fitted with a look-ahead or reorder buffer providing information about bursts that will be serviced in the near future. By looking in the buffer, the controller can detect and possibly prevent bank conflicts through reordering of requests [2, 8, 10, 15, 17]. This mechanism works well enough to totally hide the extra latency introduced, provided that there are bursts to different banks in the buffer. This solution is very effective but increases latency for the requests. Reordering is not without difficulties. If the bursts within a request are reordered they must be reassembled, which requires extra buffering. If reordering is done between requests then read-after-write, write-after-read and write-after-read hazards can occur unless dependencies are closely monitored. This requires additional logic.

SDRAM suffers from costs when switching directions, i.e. going from write to read or from read to write. When the bidirectional data bus is being reversed, NOP commands have to be issued resulting in lost cycles. The number of lost cycles differs when switching directions from write to read or from read to write. The read/write efficiency can be improved by preferring reads after reads and writes after writes [2, 8], which however results in higher latency.

Even though a DDR device transfers data on both the rising and the falling edge of the clock, commands can only be issued once every clock cycle. As a result, there may not be enough room on the command bus to issue the activate and precharge commands needed when consecutive read or write bursts are transferred. This results in lost cycles when a read or write burst has to be postponed due to a page fault. With a burst size of eight words, a new read or write command has to be issued every fourth clock cycle leaving the command bus free for other commands 75% of the time. With a burst size of four words read and write commands are issued every second cycle. First generation DDR modules supported a burst size of two. As no other commands can be issued, it is impossible to sustain consecutive bursts for a longer period of time. Read and write commands can be issued with an auto-precharge resulting in that the bank is precharged at the earliest possible moment after the transfer is completed. This saves space on the command bus and is useful when the next burst targets a closed page. The command conflict efficiency is estimated in the range of 95-100% making it a less significant source of inefficiency.

The memory controller is the interface between the system and the memory. A general memory controller consists of four functional blocks: a memory mapping module, an arbiter, a command generator, and a data path.

The memory-mapping module performs a translation from the logical address space used by the requestors to the physical address space (bank, row, column) used by the memory.

Three examples are illustrated for a memory map using five bit addresses. The first memory map, observed in FIG. 5, maps sequential addresses to the same bank. By decoding the two most significant bits into the bank number this mapping ensures that iteration is done over columns and rows before switching bank. A sequential memory map is useful when partitioning to isolate the behavior of IPs from each other since all traffic in predefined address intervals are guaranteed to hit the same bank. A disadvantage of this mapping is that a large request may hit the end of the page, resulting in a page fault.

The memory map in FIG. 6 interleaves sequential addresses in pairs of two over all four banks. The interleaving memory map has benefits since a large request interleaves over all banks eliminating the risk of page faults all together. The downside of this map is that a minimum burst length is required to hide the latencies of activation and precharging. This particular map is useful when interleaving over banks under the assumption that a burst size of two is enough for a bank to precharge and activate if needed between consecutive accesses. It is possible to use multiple memory maps for different regions. The memory map in FIG. 7 for example has two regions. The first covers the first two banks and the second the two remaining ones. The first region maps addresses sequentially first to bank one and then to bank two (as in FIG. 5). The second region changes the memory map to afford interleaved access to bank two and three. These memory maps do not overlap but still manage to use the entire physical memory.

Referring to FIG. 2 again, the arbiter 35, or scheduler, decides what request (or burst, depending on the level of granularity) will next access the memory 50. This choice can depend on the age of the requests, the amount of traffic that has already been served for that requestor and various other factors.

After the arbiter 35 has chosen the request to serve, the actual memory commands need to be generated. The command generator 36 is designed to target a particular memory architecture, such as SDRAM, and is programmed with the timings for a particular memory device, such as DDR2-400. This modularity helps adapting the memory controller for other memories. The command generator 36 needs to keep track of the state of the memory to ensure that no timings are violated. The bi-directional data path 37 is arranged for the actual data transfer to and from the memory 50. The data path 37 is relevant for the scheduler 35, due to the fact that reversing the direction of this data path 37, i.e. switching from reads to writes, results in lost cycles.

Two logical blocks may be discerned within the memory controller 30, namely a front-end and a back-end. The memory mapping module 34 and the arbiter 35 is considered a part of the front-end while the command generator 36 is a part of the back-end (See FIG. 2). In the memory controller according to the invention access to the memory is arbitrated by a dynamic front-end scheduler 35 that assigns the memory 50 in compliance with a predetermined back-end schedule.

The predetermined back-end schedule makes memory access predictable and provides an efficient gross to net bandwidth translation. The schedule is composed from read, write and refresh groups as shown in FIG. 8. A read and a write group contains a memory access of maximum burst size for every bank in the memory. These accesses are interleaved over the banks in order to achieve efficient pipelining and thus high memory efficiency. As the access pattern to the memory is determined by the back-end schedule, the memory efficiency is known, and hence the net number of memory cycles available for access by the requestors. These available memory cycles can be allocated to the requestors and subsequently scheduled dynamically however without changing the predetermined access pattern.

The memory needs to be refreshed at times and thus a refresh group has to be scheduled after a number of basic groups.

The back-end schedule yields a good memory efficiency, since some of the sources of inefficiency described before have been eliminated or bounded. For instance, bank conflicts cannot occur by construction since the read and write groups interleave over the banks, therewith providing enough time for bank preparation. Read/write efficiency is addressed by grouping read and write bursts together in the back-end schedule. This bounds the number of switches.

The appropriate back-end schedule has to be computed for a given specification of traffic consisting of minimal net bandwidth requirements and a maximum latency. This requires determining the number and layout of read, write and refresh groups in the back-end schedule. The generated ordering of the groups must offer enough net bandwidth in the read and write directions and for the banks specified by the requestors. The bandwidth allocation to the requesters takes into account the hard real-time guarantees on net bandwidth and worst-case latency. Finally, the bursts in the back-end schedule are scheduled to the different requesters in the system taking their allocation and quality-of-service requirements into account. This is done dynamically to increase flexibility. The dynamic front-end scheduler can be implemented in several ways but must be sophisticated enough to deliver the guarantees while still being simple enough to be analyzed analytically.

The computation of the back-end schedule will now be described in more detail.

The back-end schedule comprises the generated sequence of commands sent from the back-end of the memory controller to the memory. Fixing the back-end schedule makes memory access predictable, therewith allowing for a deterministic gross to net bandwidth translation. The back-end schedule should comply with a set of requirements for read and write bandwidth and for the maximum allowed latency of the requesters. The back-end schedule can be optimized for different purposes such as memory efficiency or low latency. The back-end schedule is composed from low-level building blocks, including a read group, a write group and a refresh group. Each groups consists of a number of memory commands and may differ depending on the targeted memory.

A calculation of a particular back-end schedule is now worked out in more detail for a

DDR2 SDRAM [9]. The basic principle however, applies equally to other SDRAM versions, such as SDR SDRAM and DDR SDRAM. The groups are illustrated in FIGS. 9, 10 and 11. The groups consist of a number of consecutive SDRAM-commands familiar from Table 1. The only way to make them 100% efficient with consecutive reads and writes potentially targeting different pages is to interleave memory access sequentially over all four banks and use a burst size of eight elements. The larger burst size provides enough time between successive accesses to the same bank to precharge and activate another row. The drawbacks are related to data efficiency. Data that is not aligned on a boundary of eight words and requests smaller than the selected burst size results in significant waste. All read and write commands are issued with auto-precharge to make sure that the banks are precharged at the earliest possible moment. This avoids contention on the command bus and makes the groups easier to schedule.

The basic read group is shown in FIG. 9. The read group consists of 16 cycles and data is transferred during all of them making the group 100% efficient.

FIG. 10 shows the basic write group. The group spans 16 cycles and transfers data during all of them, just like the basic read group.

All of the banks have to be precharged before a refresh command is issued. The refresh group shown in FIG. 11 is assumed to follow a read group to more efficiently pipeline the precharging of the banks. Once the refresh command has been issued there is a number of NOP commands during what is called a refresh-to-activate delay (t_{RFC}), which have to pass before a new basic group is issued. This particular refresh group is valid for a 256 Mb DDR2-400 device; a larger and faster device needs more cycles for refresh.

The back-end schedule is composed from a sequence of these blocks. As explained before, costs are involved with switching directions from read to write and vice versa. This implies that NOP instructions (in this case 2) have to be added between a read and a write group and between a write and a read group (in this case 4). This is shown in FIG. 12.

Every row in a DRAM needs to be regularly refreshed in order not to loose data. This has to be taken into account to make the memory accesses predictable, and for this reason a refresh group is created at the end of the schedule. The refresh group has to start by precharging all banks and then issue between one to eight consecutive refresh commands. If the refresh group succeeds a predefined read or write group the precharging commands of that group can be used to make the refresh group shorter. In the embodiment described here the refresh group succeeds a read group. In this way the read group shortens the refresh group with two cycles. The benefit of postponing refresh is that the overhead involved in precharging all banks is amortized over a large group. Postponing refresh is not without disadvantages however, since this makes the refresh group longer, which affects the worst-case latency. The number of cycles needed for the refresh group, t_{ref}, depending on the number of consecutive refreshes, n, is calculated in Equation 3.

t_{ref}(n)=8+15*n; n∈ [1 . . . 8] (3)

Knowing the refresh group length t_{ref}(n) and the average refresh interval T_{REFI} the maximum available number of cycles for read and write groups between two refreshes, tₐᵥₐᵢₗ is determined, as shown in Equation 4. This effectively determines the length of the back-end schedule.

tₐᵥₐᵢₗ=n.t_{REFI}−t_{ref}(n); n∈ [1 . . . 8] (4)

The back-end schedule is composed of read, write and refresh groups. It will now be determined how many read and write groups are required and how these should be placed in the back-end schedule. This is a generalization of what is found in [8] where only the equivalent of a single group is allowed before switching direction. This approach works well for older memories but the increasing cost of switching direction has made this generalization necessary. The number of read and write groups is related to the read and write requirements of the requestors in the system. In the current approach it was chosen to sum the total bandwidth requested for reads and for writes and to subsequently let the requested proportions between read and write groups in the schedule be determined by the fraction, α, determined by these numbers. This fraction is calculated in Equation 5 where wᵣ(d) is a request function returning the bandwidth requested by requestor r in direction d.

$$α = {\sum }_{∀ r ∈ R} \frac{{w}_{r} ( read )}{{w}_{r} ( write )} \qquad ( 5 )$$

A number of consecutive read and write groups, c_{read} and c_{write} is to be determined to represent this ratio and to constitute the basic group. The chosen values of c_{read} and c_{write} define the provided read/write ratio, β.

$$β = \frac{{c}_{read}}{{c}_{write}} \qquad ( 6 )$$

The basic group is defined by the set of write groups followed by the set of read groups and padded with the extra NOP instructions needed for switching. The basic group is preferably repeated until no more can be fitted before refresh. The maximum allowable number k of repeated basic groups is calculated in Equation 7 where t_{switch} is the number of NOPs needed to switch directions from read to write and back again. For DDR2-400 t_{switch}=t_{rtw}+t_{wtr}=6 cycles. t_{group} is the time needed for the read or write groups, both 16 cycles for DDR2-400.

$$k = ⌊ \frac{{t}_{avail}}{( {c}_{read} + {c}_{write} ) \cdot {t}_{group} + {t}_{switch}} ⌋ \qquad ( 7 )$$

In general it is desired to place groups having the same direction in sequence for efficiency reasons. This obviates issuing extra NOP instructions needed to make the groups fit together. In the static schedule this heuristic is, however, only valid to a certain extent since large basic groups may not repeat well with respect to refresh due to the non-linearity of Equation 7. This means that a large group may be put in sequence a number of times, but that a large number of cycles are left unused before the end of the average refresh interval because insufficient additional time is available for an additional basic group. This causes the refresh group to be scheduled prematurely yielding an inefficient schedule although the basic group, as such, is very efficient. This is in particular the case if the ratio between the brackets of the floor function is just slightly smaller than the closest integer value. The impact of this effect becomes larger with a larger c_{read} and c_{write}.

A problem with putting all groups in the same direction in sequence is that the worst-case latency for a request increases significantly since there may be a large amount of bursts going in the interfering direction before scheduling of a particular request can be considered. The maximum latency of the requestors constrains the number of read and write groups that can be put in sequence without violating the guarantees. The worst-case latency for a request depends on both the number of consecutive read and write groups. This will be described in more detail in a further part of the description.

It should further be taken into account that fractions sometimes cannot be accurately represented without a very large numerator or denominator. As the latency constrains the number of consecutive groups in a particular direction it is apparent that memory efficiency will, for some read/write ratios, have to be traded for a lower latency.

The total efficiency of a solution depends on two components. The first component is due to the regular sources of inefficiency, discussed before, such as read/write switches and refresh resulting in lost cycles. The second component relates to how close the provided read/write mix, β, corresponds to the requested, α. The first component is, in some regard, significant in all memory controlling schemes but the second one is inherent to this approach. The second one will be considered in more detail after a formal definition of a back-end schedule is given.

For a target memory a back-end schedule, θ, is defined by a three-tuple (n, c_{read}, c_{write}), where n is the number of consecutive refresh commands in the refresh group and c_{read} and c_{write} the number of consecutive read and write groups respectively in the basic group.

The schedule efficiency, e_{θ}, of a back-end schedule θ is defined as the fraction between the amount of net bandwidth provided by the schedule, S′₇₄ , and the available gross bandwidth, S.

$${e}_{θ} = \frac{{S}_{θ}^{′}}{S} \qquad ( 8 )$$

Data is transferred in all cycles of the read and write groups. Only during the refresh cycle and when switching directions data cannot be transferred. The efficiency of a back-end schedule targeting a specific memory is expressed in Equation 9. The equation is written in two forms, one focusing on the fraction of clock cycles with data transfers and the other one on the fraction of cycles with no transfer.

$$\begin{matrix}{e}_{θ} = \frac{( {c}_{read} + {c}_{write} ) \cdot k \cdot {t}_{group}}{( ( {c}_{read} + {c}_{write} ) \cdot {t}_{group} + {t}_{switch} ) \cdot k + {t}_{ref} ( n )} \\ = 1 - \frac{{t}_{switch} \cdot k + {t}_{ref} ( n )}{( ( {c}_{read} + {c}_{write} ) \cdot {t}_{group} + {t}_{switch} ) \cdot k + {t}_{ref} ( n )}\end{matrix} \qquad ( 9 )$$

e_{θ}is a metric indicating how well gross bandwidth is translated into net. Although this is a relevant number, the total efficiency needs to take into account that the groups in the schedule may not correspond completely to what was requested.

The condition α≠β results in an over-allocation for either reads or writes. This has a negative impact on the mix efficiency, eₘᵢₓ, defined as the difference between the requested and the provided read/write ratio.

eₘᵢₓ=|α−β| (10)

The total efficiency, eₜₒₜₐₗ will be used as the metric of efficiency in this application, wherein the total efficiency, eₜₒₜₐₗ, of a back-end schedule, θ, is defined as the product between the schedule efficiency, e_{θ}, and the mix efficiency, eₘᵢₓ.

The allocation scheme determines how to distribute the bursts in the back-end schedule to guarantee the bandwidth requirements of the requestors in the system. In order to provide a guaranteed service an allocation scheme has to provide isolation for a requester, so that it is protected from the behavior of the other requesters. This property, known as requestor protection, is important in real-time systems to prevent a client from over asking and using resources needed by another. Protection is often accomplished by using a currency in the form of credits representing how many cycles, bursts or requests will be served maximally before access is granted to another requestor.

Before describing here in more detail the method of allocation in the preferred embodiment of the invention a short reference is made to related work in the field of bandwidth allocation. Lin et al. [10] allocate a programmable number of service cycles in a service period. This means allocating gross bandwidth but the disclosure does not provide sufficient information to determine whether the bandwidth is guaranteed or not. In [17] a number of requests are allocated in a service period, which translates into a gross bandwidth guarantee as long as the size of the requests is fixed.

The present invention aims to allocate and to guarantee net bandwidth. In the preferred embodiment described here in more detail, the allocation problem is approached on a slightly finer level of granularity than is the case in [17] by guaranteeing a number of bursts in the back-end schedule per service period. This finer level of granularity enables a wider range of dynamic scheduling algorithms.

The system and method according to the present invention guarantee that a requestor, during a predefined time period, gets a certain amount of net bandwidth, Aᵣ, to the memory. This is conveniently expressed in terms of Equation 11 and the bursts in the static schedule. A requestor is guaranteed aᵣ bursts out of every p. This means allocating a fraction of the available bandwidth S′_{θ}, defined by the total bandwidth and the efficiency of the back-end schedule, to a requestor.

$${A}_{r} = \frac{{a}_{r}}{p} \cdot {S}_{θ}^{′} \qquad ( 11 )$$

For the allocated rates to make any sense no more bandwidth can be allocated to the set of requesters, R, than available, meaning that Equation 12 must hold.

$${\sum }_{∀ r ∈ R} \frac{{a}_{r}}{p} \leq 1 \qquad ( 12 )$$

Preferably a net bandwidth should be guaranteed without choosing a particular front-end scheduling algorithm to use. In order not to constrain the scheduling algorithm it should be allowed to schedule the requesters in any order since this lets the latency and buffering trade-off to be settled with the definition of the scheduling algorithm. To accomplish this, the following assumptions are made about properties of the requesters and the scheduling algorithm used.

All requesters have service periods of equal length.

A requester can make use of any burst, regardless of destination bank and direction.

A requestor, r, does not get more than aᵣ bursts in p.

The latter assumption does not apply to each case. It will be discussed in another part of the description how to relax this assumption. These three assumptions simplify the scheduling so that it may be done arbitrarily. This is the situation shown in FIG. 13: any burst can be granted to any requestor within their allocation.

Most scheduler algorithms require for their properties, in particular with respect to bandwidth guarantees, to be valid that the requestors, r, are backlogged, i.e. that their request queues are not empty. This follows from the fact that a request cannot be served unless it is available.

The service periods of the requesters are aligned in FIG. 13. This is a special case and this property is not required. The present allocation scheme does not only allow the service periods to be unaligned, but also to be sliding. This concept is illustrated in FIG. 14. Allowing sliding service periods is advantageous in that a requestor that has been idle benefits from bandwidth guarantees right away and does not have to wait for the service period to restart, a delay that is potentially very long depending on the granularity of the scheduling and the quality-of-service level of the requester. The situation in FIG. 14 is schedulable with the same prerequisites as before. The service period of a requestor does not start until there is a request to schedule. Consequently a requestor, r, is guaranteed aᵣ bursts in a service period.

When the back-end schedule drives the memory accesses it has to be known beforehand that the requesters have bursts available for the combination of banks and directions present in the period p. This requirement is formally defined with the assumption that a requestor can make use of any burst, regardless of destination bank and direction and the requirement that the requestors are backlogged.

There are some constraints on the length of the service period, p. It is assumed that the service period spans an integral number of basic groups. This prevents the offered read/write mix from changing between the different service periods and guarantees that there are enough bursts in both directions illustrated in FIG. 15. This Figure shows four service periods with different read/write mixes. The assumption that the service period spans an integral number of basic groups can be expressed in the following equation.

p.x=k;p,x,k∈N (13)

Wherein x is a variable defining the number of times p repeats in one revolution of the back-end schedule. Equation 13 can be expressed, as x needing to be a factor in k. This situation is depicted in FIG. 16. This figure shows valid values for x when the service period is at a finer level of granularity than the back-end schedule.

Otherwise p can be chosen on a higher level of granularity than the back-end schedule.

In this case p needs to correspond to a number, i, of revolutions of the back-end schedule.

Equation 14 then replaces equation 13. This situation is shown in FIG. 17.

p=k.i;k,p,i∈N (14)

The above assumptions ensure that the service periods have the specified read/write mix. This allocation scheme however does not deliver hard real-time bandwidth guarantees. Transaction boundaries cause problems if a requestor changes directions, as shown in FIG. 12.

In the illustrated situation a single requestor is allocated all of the bursts. Once the read burst is finished a number of bursts cannot be used since they are in the wrong direction. This prompts another assumption about the requesters that a requestor only requests reads or writes, but not both.

Consider further the situation with an interleaved memory map depicted in FIG. 18. This shows that using an interleaving memory map causes situations that are not arbitrarily schedulable. The requesters do not have more bursts going in any direction than what is available, but still an arbitrary scheduling of the bursts may result in waste. If r₀ gets the first three bursts, then no one can make use of the fourth burst, which is wasted even though no requestor misbehaved. This may result in some requestor failing to meet its guarantees. Determining beforehand what bank the requestors will request relieves the problem. That can be done using one of two bank access patterns: memory-aware IP design and partitioning. Both approaches can be used to create a hard real-time guarantee on net bandwidth.

Memory-aware IP design means here a system that is designed with the multi-bank architecture of the target memory in mind. This may involve making every memory access request all banks in sequence and thus have a system that is perfectly balanced over the banks by construction. A partitioned system guarantees that a request can be scheduled and that a slot is only wasted if a requestor is not backlogged. Partitioning comes with several challenges and impacts the efficiency of the solution. This is discussed elsewhere in the description In [10, 17] the number of cycles and requests per service period is manually determined and programmed at device setup. It is preferred to automate this step and to provide allocation functions that derive this programming from the specification.

The considerations to be taken into account for the allocation function are described now in more detail. In the first place the number of requested bursts in a service period needs to be calculated. To that end the number of revolutions of the back-end schedule per second is calculated according to Equation 15, i.e. by calculating the number of available clock cycles in a second and dividing it by the number of cycles, t_{θ}, needed to revolve the back-end schedule once.

$${n}_{θ} = \frac{\frac{1}{{t}_{CLK}}}{{t}_{θ}} \qquad ( 15 )$$

Subsequently the bandwidth requirement per second is translated into a requirement per service period, with w denoting the bandwidth requirement of the requestor, s_{burst} the burst size programmed in the memory, in this case 8, and s_{word} the word width. Equation 16 shows how to calculate this burst requirement. This is referred to as the real requirement since this is not rounded off.

$${n}_{real} = \frac{\frac{ω}{{c}_{burst} \cdot {c}_{word}}}{{n}_{θ} \cdot x} , {n}_{real} ∈ {R}^{+} \qquad ( 16 )$$

The number of bursts that needs to be allocated to the requestor, the actual requirement, preferably is a multiple of the request size of the requestor. In this way a request is always served in one service period, which is good for the worst-case latency bound. However, this also increases the effect of discretization errors during allocation thus reducing memory efficiency for systems with short service periods or large request sizes. The actual requirement for a requestor, r, is computed in Equation 17.

$${n}_{actual} = ⌈ \frac{{n}_{real}}{{σ}_{r}} ⌉ \cdot {σ}_{r} \qquad ( 17 )$$

The ratio between the actual and the real number of requested bursts is a measure of over-allocation due to the discretization errors mentioned above.

It is now shown how a scheduling solution can be computed. A scheduling solution, γ, consists of the tuple formed by a back-end schedule, θ, and a definition of the service period x.

As stated before, the non-linearity of the properties of the back-end schedule makes it difficult to find an optimal solution by an analytical computation. However a suitable solution can be found by an exhaustive search within a reduced search space. Since the algorithm computes the schedules for the different use-cases offline, it has no real-time demands making an exhaustive search a feasible option. The search space is, however, bounded to make the run-time of the algorithm predictable.

The algorithm consists of four nested loops iterating over the number of consecutive refreshes, read groups, write groups and the possible service periods (n, c_{read}, c_{write} and x respectively). The number of consecutive refreshes supported by the memory bounds the refresh loop. This number is eight for all DDR memories. The read and write group loops are more difficult to bound due to their interdependence and their dependence on the allocation. The number of unique factors in k for every solution bounds the possible service periods. For every possible solution the efficiency is calculated provided that bandwidth allocation, described elsewhere in the description, was successful and provided that the latency constraints are satisfied. The search space is limited by not adding further groups in the one direction if there is a latency violation in the other unless more groups are added in this direction as well. If both read and write latency are violated by the same solution, then no better valid solution can be found with the present refresh settings. This means that the latency calculations bound the loops if no absolute max values, READ MAX and WRITE MAX, are provided. The algorithm ends by selecting the optimal solution for the set of valid solutions. The optimization criteria can vary from memory efficiency, or lowest average latency to most efficient allocation.

FIG. 19 shows an algorithm for computing a back end scheduling solution.

In steps S1 to S4, the algorithm respectively initializes the number of consecutive refreshes n, the number of consecutive read groups c_{read}, the number of consecutive write groups c_{write}, and the number of service periods x during a revolution of the back-end schedule. The numbers are initialized at 1 for example.

In step S5 it is verified whether a back-end schedule using the parameters n, c_{read}, c_{write}, x complies with the bandwidth and latency constraints of the requestors. If this is the case, this parameter set is stored in step S6. In step S7 it is verified whether all service periods have been examined for the parameters n, c_{read}, and c_{write}. If this is not the case a next value for x is selected in step S8 and step S5 is repeated.

If indeed all service periods have been examined than it is verified in step S9 whether the maximum number of write groups is reached. If that is not the case the number of write groups c_{write} is increased by one in step S10, and control flow continues with step S4. If the maximum number of write groups c_{write} is reached indeed, it is verified in step S11 whether also the maximum number of read groups is reached. If this is not the case the number of read groups c_{read} is increased by one in step S12, and control flow continues with step S3. If the maximum number of read groups is reached indeed it is verified in step S13 whether also the maximum number of refreshes is reached. If this is not the case the number of refreshes n is increased by one in step S14. If this is indeed the case all possible combinations have been examined and the algorithm finishes by selecting the most optimal of the stored solutions in step S15. The algorithm shown in FIG. 19 is further optimized in that it has two additional steps S16 and S17. If it is found out in step S5 that a backend schedule using the parameters n, c_{read}, c_{write}, x does not comply with the bandwidth and latency constraints of the requestors, it is verified in step S16 whether there is a read violation. If that is the case the loop for the number of write groups is broken, as a further increase in the number of write groups will only further deteriorate the read latency. Instead control flow continues with step S11. If there is no violation for the read latency control flow continues with step S17. In step S17 it is verified whether there is a violation for the write latency. If that is the case the loop for the number of read groups is broken, as a further increase in the number of read groups will only further deteriorate the write latency. Instead control flow continues with step S13. If there is no violation for the write latency control flow continues with step S7.

The allocation scheme guarantees that a number of bursts, determined by an allocation function, are serviced to the requestors every service period. A dynamic front-end scheduler is introduced that bridges between the fixed back-end schedule and the allocation scheme. Flexibility is increased by distributing the allocated bursts dynamically according to the quality-of-service levels of the requestors.

Five general properties of scheduling algorithms are relevant here: work conservation, fairness, protection, flexibility and simplicity.

A scheduling algorithm can be classified as work conserving or non-work-conserving.

A work-conserving algorithm is never idle when there is something to schedule. In a non-work-conserving environment requests get associated with an eligibility time and are not scheduled until this time, even though the memory may be idle. It is appreciated that a work-conserving algorithm yields a lower average latency than a non-work-conserving since it achieves higher average throughput. The advantage of non-work-conserving scheduling algorithms is that they can reduce buffering by providing data just in time and that they put bounds on jitter. A number of work-conserving and non-work-conserving scheduling algorithms are overviewed in [18, 19].

A fair scheduling algorithm is expected to serve the requesters in a balanced fashion according to their allocation. Perfect fairness is formally expressed in Equation 18 with Sₖ denoting the amount of service given to requestor k in the half-open time interval [t0; t1).

$$∀ {t}_{1} , {t}_{2} and ∀ k , j ∈ R \\ \vert \frac{{s}_{k} ( {t}_{0} , {t}_{1} )}{{a}_{k}} - \frac{{s}_{j} ( {t}_{0} , {t}_{1} )}{{a}_{j}} \vert = 0 \qquad ( 18 )$$

It follows from Equation 18 that a perfect fairness can only be achieved in a system where work is infinitely divisible, a fluid system. A scheduling algorithm for this kind of system is proposed in [13]. The more general expression in Equation 18 is used if the system in question is not a fluid system. Several scheduling algorithms [3, 4, 13, 16] have been proposed that work with this kind of fairness bounds.

$$\vert \frac{{s}_{k} ( {t}_{0} , {t}_{1} )}{{a}_{k}} - \frac{{s}_{j} ( {t}_{0} , {t}_{1} )}{{a}_{j}} \vert < κ \qquad ( 19 )$$

It is clear from Equation 19 that the bound on fairness, κ, grows with the level of granularity in the system. It is thus possible to create an algorithm with higher degree of fairness in a system scheduling SDRAM bursts rather than requests since this is a closer approximation of a fluid system. In this respect a finer level of granularity is advantageous. Fairness impacts buffering. The channel buffers bridge between the arrival and the consumption processes. The memory controller determines the consumption process but the arrival process is assumed, to be unknown. For this reason these processes must be assumed to have a maximum phase mismatch. A high level of fairness makes the consumption process less bursty, causing the buffers to drain more evenly. This brings the worst-case and average-case buffering closer together.

Fairness has a dualistic impact on latency. When interleaving requests of the same size, the worst-case latency remains the same but the average latency increases since the service of the requests finishes later. The impact of this grows with finer granularity. If requests have different sizes, fairness prevents a small request from being blocked by a large one and from receiving a high latency and an unreasonable wait/service ratio.

In the present embodiment the allocation scheme provides fairness in the sense that the requestors get their allocated number of bursts in a service period, the smaller the period the larger the level of fairness. The front-end scheduler dynamically assigns the memory in accordance with the allocated numbers.

It has been observed in packet-switched networks employing a FCFS algorithm that a host can claim an arbitrary percentage of the bandwidth by increasing its transmission rate. This enables malfunctioning or malicious hosts to affect the service given to well-behaving hosts. Nagle [11] addresses this problem by using multiple output queues and servicing them in a Round Robin fashion. This provides isolation and protects a host from the behavior of others.

Protection is fundamental in a system providing guaranteed services and for that reason this property is built into the allocation scheme, as described before, and is provided regardless of the scheduling algorithm in use. Over-asking results in buffers filling up, which can cause data loss in a lossy system or flow control to halt the producer in a loss less one. Either way the service of the other requestors is not disrupted.

A scheduling algorithm must be flexible and cater to diverse traffic characteristics and performance requirements. These kinds of traffic and their requirements are well recognized. Many memory controllers deal with these differing demands by introducing traffic classes. Although the memory controllers are quite different the chosen traffic classes are very similar since they correspond to well-known traffic types. Three common traffic classes are identified:

Low latency (LL)

High bandwidth (HB)

Best effort (BE)

The low latency traffic class targets requestors that are very latency sensitive. In most memory controllers the requesters in this class have the highest priority, at least as long as they stay within their allocation [10, 12, 16, 17]. In their attempts to minimize latency Lin et al. [10] enables requests within this traffic class to pre-empt other requests of lower priority. This reduces latency at the expense of memory efficiency and predictability. Some memory controllers abstain from reordering low latency requests in order to keep latency down.

The high bandwidth class is used for streaming requestors. In some systems these have no bounds on latency allowing the requests in this traffic class to be reordered and thus sacrifice latency in favor of memory efficiency.

The best effort traffic class is found in [10, 16, 17] and these requests have the lowest priority in the system. They have no guaranteed bandwidth or bounds on latency but are served whenever there is bandwidth left over from the higher priority requestors. It is important to keep in mind that if the left over bandwidth is lower, on average, than the requested rate from the requesters in this traffic class requests will have to be dropped to prevent overflows.

There are limitations on the complexity of the scheduling. It must be feasible to implement in hardware and run at high speeds. The time available for arbitration depends on the size of the service unit used. In the present implementation with the basic unit to be scheduled is a DDR bursts of eight words. This means that re-arbitration is needed every four clock cycles, corresponding to 20 ns for DDR2-400 and 12 ns for DDR2-667. This provides a lower bound on the speed of the arbiter.

In a hard real-time system the worst-case performance is of utmost importance and must be well known if guarantees are to be provided. A modular approach is used to compute the worst-case latency for a request. The worst-case latency is calculated as the sum of a number of latency sources. These are

Bursts needed in the direction of the request before it is finished.

Read/write switches and bursts going in the interfering direction.

Interfering refresh groups

Arrival/arbitration mismatch

The below analysis is kept general so that it is valid for all scheduling algorithms that comply with the fairness bounds imposed by the allocation scheme. A tighter bound can be derived by examining a particular algorithm. The analysis is not tailored to a particular quality-of-service scheme. It does require however, the existence of a partial ordering between the priority levels used.

As a worst-case, it is assumed that a request arrives at a point in time where the interference from the other groups is maximized. The worst-case arrival for a request is to end up just in front of the last sequence of bursts going in the interfering direction. In that case not only the maximum number of unusable bursts is up for scheduling, but also every request has at least one refresh included in the worst-case latency. The worst-case positions in the back-end schedule for reads and writes are illustrated in FIG. 20. First the number of bursts is computed that is required to fit a request of σword words by requestor r. The request is translated into a number of bursts, σ_{burst}, for example of eight words to match the granularity of the scheduler.

$${σ}_{burst} = ⌈ \frac{{σ}_{word}}{8} ⌉ \qquad ( 20 )$$

Now it is considered how many bursts are needed in the direction of the requestor to guarantee that the request finishes. The request needs σ_{burst} bursts in the proper direction to finish. Since no assumptions are made about the fairness of the scheduling algorithm these are assumed to be as late as possible. At this stage priorities come into play. A requestor can be forced to wait for all other requestors of equal or higher priority in the same direction. The set R′ᵣ is defined to contain all such requesters.

The request is thus finished after the number of bursts in the right direction n_{left} computed by Equation 21. The equation calculates the combined allocation of all 10 requestors in

R′ᵣ except for aᵣ since only σ_{burst}<=aᵣ bursts are required by r for the request to be finished. The computed value must be multiplied by the number of banks if the requestors are partitioned to specific banks since only one out of n_{banks} bursts are useful to serve the request.

$${n}_{left} = ( {\sum }_{∀ k ∈ {R}_{r}^{′}} {a}_{r} ( d ) ) - {a}_{r} ( d ) + {σ}_{burst} \qquad ( 21 )$$

The total number of bursts to wait for in order to get n_{left} bursts in the right direction may vary for reads and writes since the number of consecutive bursts, c_{read} and c_{write}, can be different. Equation 23 calculates the time lost to bursts in the interfering direction, including the actual number of switches n_{switches} calculated by Equation 22. The factor, c_{interfering}, corresponds to the number of consecutive bursts going in the interfering direction and is thus equal to c_{read} for a write request and c_{write} for a read request.

$$\begin{matrix}{n}_{switches} = ⌈ \frac{{n}_{left}}{{c}_{read}} ⌉ & ( 22 ) \\ {t}_{direction} = {n}_{switches} \cdot ( {t}_{switch} + {c}_{interfering} \cdot {t}_{burst} ) & ( 23 )\end{matrix}$$

As previously concluded the worst-case latency always contains at least one refresh group. For every revolution of the back-end schedule there is an additional refresh group. The number of refresh groups is conveniently expressed in terms of the proportion between the duration of the back-end schedule and the duration of the service period, x, due to the constraints for the service period. The number of refreshes interfering with the transaction is calculated in Equation 24.

$${n}_{ref} = ⌈ \frac{1}{x} ⌉ \qquad ( 24 )$$

If a request becomes eligible just after an arbitration decision is made the cycles until re-arbitration are lost. The impact of this grows with longer arbitration periods and thus impacts systems with the memory-aware bank access pattern, shown in Equation 25 to a larger degree than partitioned systems (Equation 26).

t_{mismatch}=4.n_{banks}−1 (25)

t_{mismatch}=4−1=3 (26)

The worst-case latency is now calculated by combining the various latency sources. This is shown in Equation 27 where t_{period} is the number of cycles in a service period, t_{burst} is the number of cycles needed for a burst and, t_{ref} is the number of cycles in the refresh group. tₗₐₜ is thus the worst-case latency expressed in clock cycles.

tₗₐₜ=n_{left}.t_{burst}+t_{direction}+n_{ref}.t_{ref}+t_{mismatch} (27)

Although there are many factors affecting the worst-case latency, the latency with which a request is handled is to a large degree affected by n_{left}. This means that a low latency is accomplished by giving the sensitive requestors a high priority and by carefully selecting the bank access pattern and scheduling algorithm. Equations 27 and 23 also show that it is possible to further reduce latency by minimizing n_{direction}. This is achieved by constraining the number of maximum consecutive read and write groups in the back-end schedule and by trading a lower latency for lower memory efficiency.

An objective of the presented bandwidth allocation scheme is to place as few constraints as possible on the scheduling algorithm. The allocation scheme states that the algorithm used must provide an allocated number of bursts to every requestor in a service period. No assumptions are made regarding the order in which the requestors are assigned their allocated number of bursts, which provides great flexibility in the choice of the scheduling algorithm.

FIG. 21 schematically shows the algorithm according to the invention.

In step S1 the front-end scheduler receives memory access requests from the requestors.

In step S2 the type of access requested is determined, e.g. the direction write/read, and the bank for which access is desired,

In step S3 the requested access type is compared with the access type authorized for a respective time-window according to the back-end schedule,

In step S4 a selection is made containing the incoming requests that have the prescribed access type for the relevant time-window,

In step S5 a dynamic scheduling algorithm assigns one of those requests remaining in the selection. Then the algorithm repeats with step S1 to scheduled the next burst of the memory. For clarity the steps S1 to S3 are shown in the chronological order. However if will be clear to the skilled person that these steps may be carried out in a pipelined manner.

Step S5 may be carried out by a conventional dynamic scheduling algorithm, e.g. the Deficit Round-Robin (DRR) scheduling algorithm. Two variations of this algorithm are introduced in [16]. The present implementation is based on one of them, called DRR+. DRR+ is designed as a fast packet-switching algorithm with a high level of fairness. It operates on the level of packets with variable size, which is very similar to the requests considered in the present model, and can easily be modified to work with bursts. In the present embodiment two traffic classes are employed, low latency and high-bandwidth. In the present embodiment it is presumed that each requestor has hard real-time guarantees, hence best effort traffic is disregarded.

Since the back-end schedule has decided on the bank and direction of a particular burst only requests going in that direction can be considered and does thus constitute a subset of the requesters eligible for scheduling. Lists, similar to the active-lists of DRR+, are maintained in FCFS order for every quality-of-service level. A previously idle requestor is added to the corresponding list when a request arrives at an empty request buffer. These lists are maintained in one of two ways depending on which of two variations of the algorithm is applied. The first variation does scheduling on the request level and does not select another request from the eligible subset until the entire request is finished. The requestor is added to the bottom of the list when a request is finished, provided that there are more requests in the request queue. The second variation of the algorithm operates on the burst level and moves the requestor to the bottom of the list for every scheduled burst.

The first variation reduces the amount of interleaving and provides a lower average latency although the worst-case latency remains the same. The amount of buffering required is proportional to the burstyness of the arrival and consumption processes and the worst-case latency. The arrival process and worst-case latency is unchanged for the two variations but the first variation has more bursty consumption and has thus a larger worst-case buffer requirement.

The lists are examined in a FCFS order and the first eligible requestor is scheduled.

To give low latency requestors the quality-of-service they require they are always served first. If there are no backlogged low latency requestors, or if they have run out of allocation credits, a high bandwidth requestor is picked. This situation is illustrated in FIG. 22.

The FCFS nature of the algorithms increases fairness beyond that of the allocation scheme, which means that tighter latency bounds than those calculated for the more general case can be derived.

A model of the memory controller model according to the invention was implemented in SystemC and was simulated using the Aethereal network-on-chip simulator described in [5]. The requesters were specified using a spreadsheet and were simulated with traffic generators. The traffic generator for a requester, r, sends requests periodically with the period calculated in Equation 28.

$${10}^{9} \frac{{σ}_{r}}{{ω}_{r}} \qquad ( 28 )$$

A network fitting the specification is generated by an automated tool flow as described in [6]. All requests were transmitted across the network as guaranteed service traffic ensuring ordered non-lossy delivery with time related performance guarantees. In order for the latency measurements to be comparable to the results from the analytical model it was enforced that the service of a request did not stall while waiting for write data to arrive. This is accomplished by making write requests eligible for scheduling when all their data have arrived.

In Table 3 an example system is presented that is used in the test environment. The system has 11 requestors, r₀, . . . ,r₁₀ ∈ R, and is based on the specification of a video processing platform with two filters. The bandwidth requirements of the requestors were scaled to achieve a suitable load for a 32-bit DDR2-400 memory with a peak bandwidth of 1600 MB/s. The specified net bandwidth requirements correspond to approximately 70% of the peak bandwidth. Also a latency sensitive CPU with three requesters (r₈, r₉ and r₁₀) was added to the system.

TABLE 3
Specification of requestors for an
example video processing system.

| | | Request | Band- | | | |
|---|---|---|---|---|---|---|
| | | size | width | Max lat. | Traffic | |
| Requestor | Direction | [B] | [MB/s] | [ns] | class | Partition |
| r0 | write | 128 | 144.0 | 6000 | HB | 0 |
| r1 | write | 128 | 72.0 | 6000 | HB | 1 |
| r2 | read | 128 | 144.0 | 6000 | HB | 0 |
| r3 | read | 128 | 72.0 | 6000 | HB | 1 |
| r4 | write | 128 | 144.0 | 6000 | HB | 2 |
| r5 | write | 128 | 144.0 | 6000 | HB | 3 |
| r6 | read | 128 | 144.0 | 6000 | HB | 2 |
| r7 | read | 128 | 144.0 | 6000 | HB | 3 |
| r8 | read | 128 | 50.0 | 1300 | LL | 1 |
| r9 | read | 128 | 20.0 | 1300 | LL | 1 |
| r10 | write | 128 | 50.0 | 1300 | LL | 1 |

The load and service latency requirements are not aggressively specified in order to find solutions using both the partitioned and the memory-aware bank access patterns to compare the results. The request size has been set to 128 B (4 bursts) for all requesters to be compatible with the memory-aware access pattern. This is not unreasonable for communication between high bandwidth requesters via shared memory or for the communication resulting from cache misses in a level 2 cache.

A back end schedule is generated which provides the most efficient solution satisfying the latency constraints of the requestors.

The example system is partitioned as shown in Table 3. Each of the two filters has four requesters for reading and writing luminance and chrominance values. One read and one write requestor is partitioned to every bank and the CPU is partitioned to the bank with the lowest load. This assumes that the data required by the CPU is located in that bank or that the CPU is independent of the filters.

Partitioned systems are difficult to balance evenly over the banks causing allocation to fail. This problem is discussed in Appendix B. The computed scheduling solution for the partitioned system is shown in Equation 29.

γ_{partitioned}=((1; 8; 6); 3) (29)

According to this scheduling solution the schedule has 8 read groups and 6 write groups for each refresh group. The service period is repeated three times every revolution of the back end schedule.

According to equation 4 and the specification for the SDRAM used the available time for each revolution of the back end schedule is 1537 cycles. Hence, it follows from equation 7 that the number of times k that a basic group is repeated is 6. As the service period is repeated 3 times for every revolution it follows that a service period corresponds to two basic groups. As the basic group is repeated 6 times there is a total amount of (8+6)*6=84 read/write groups in the schedule. Every read/write group contains four SDRAM burst resulting in a total of 84*4=336 SDRAM bursts in the schedule. Hence the amount of SDRAM bursts in one service period equals 336/3=112. The bursts that are allocated in the allocation table are SDRAM bursts, but note that they are allocated in multiples of 4 since a group accesses all banks in sequence.

The efficiency of the calculated schedule is 95.8%, meaning that the refresh group and read/write switches account for less than 5% of the available bandwidth. This is an efficient gross to net bandwidth translation.

The basic group consists of eight read groups followed by six write groups. This is not a very good match for the specified read/write ratio, which results in a mix efficiency of

78.5%. A closer approximation to the requested ratio can be accomplished but this has unwanted effects. The fact that allocation is done in multiples of the burst size causes small changes in the schedule to significantly change the allocation of the requestors. This causes a strong increase in the worst-case latency for the low latency requesters if another write group is added.

The service period is determined to consist of three basic groups, resulting in three service periods for every revolution of the back-end schedule. Making the service period shorter than the schedule lowers the worst-case latency bounds. It is no longer possible to maintain the shorter service period if a read group is removed since this causes the number of repetitions before refresh, k, to change. That again causes latency requirements to fail.

A consequence of the shorter service period is that there are fewer bursts, 112 instead of 336, to allocate to the requestors, increasing the significance of discretization errors during allocation. Table 4 shows the results of the bandwidth allocation.

TABLE 4
Allocated bursts per service period for the partitioned system.

| Requestor | Allocated bursts |
|---|---|
| r0 | 12 |
| r1 | 8 |
| r2 | 12 |
| r3 | 8 |
| r4 | 12 |
| r5 | 12 |
| r6 | 12 |
| r7 | 12 |
| r8 | 4 |
| r9 | 4 |
| r10 | 4 |

The allocation of this scheduling solution results in 711.6 MB/s being allocated to cover the 574.0 MB/s requested for reads. 656.9 MB/s is allocated for writes requiring only 554.0 MB/s. This results in a total over-allocation due to discretization of 21.3%, which is a very large number. The total efficiency of this system is computed in Equation 30.

eₜₒₜₐₗ=e_{θ}.eₘᵢₓ=0.752=75.2% (30)

The scheduling solution for the memory-aware system looks different from that of the partitioned system, as shown in Equation 31

γ_{aware}=((2; 10; 10); 9) (31)

The basic group is longer in this schedule and consists of ten read and ten write groups. This results in fewer read/write switches, which is advantageous for memory efficiency.

The memory-aware schedule ends up being slightly more effective, for this particular use-case, with a schedule efficiency of 96.9%. The mix efficiency of this system is 96.5% since equally many read and write groups come fairly close to the requested ratio. The request group contains two refresh commands making this schedule approximately twice as long as for the partitioned system.

The service period is equal to one basic group schedule yielding only 80 bursts to allocate for this particular schedule. The allocation is shown in Table 5.

TABLE 5
Allocated bursts per service period for the memory-aware system

| Requestor | Allocated bursts |
|---|---|
| r0 | 8 |
| r1 | 4 |
| r2 | 8 |
| r3 | 4 |
| r4 | 8 |
| r5 | 4 |
| r6 | 8 |
| r7 | 8 |
| r8 | 4 |
| r9 | 4 |
| r10 | 4 |

The short service period is not good for allocation since discretization errors become very significant. 697.7 MB/s is allocated for read requests and 620.2 MB/s for the write requests.

The total efficiency of this system is calculated in Equation 32. The equation shows that the efficiency is significantly higher for the memory-aware system, since the need to reduce the service period caused a strong decrease in the mix efficiency for the partitioned system.

eₜₒₜₐₗ=e_{θ}. eₘᵢₓ=0.935=93.5% (32)

Now an analysis is provided of the net bandwidth delivered to the requestors in the simulated environment. The simulated time is 10⁶ ns, which corresponds to more than 13000 revolutions of the back-end schedule. There are some initial delays before requests arrive at the memory controller over the network but the simulated time is considerably more than needed for the results to converge.

FIG. 23 shows the cumulative bandwidth supplied to the requesters in the memory-aware system. Results are not shown for the partitioned system since they are nearly identical, as expected. The results are a number of straight lines ending in the targeted levels, as shown in Table 6. The delivered bandwidth corresponds nicely to the requested scaled to fit the simulation time. The minimal discrepancy is attributed to the initial delay. This means that net bandwidth is delivered to the requestors in real-time.

TABLE 6
Net bandwidth delivered to the requestors after 10⁶ ns.

| | Net |
|---|---|
| | bandwidth |
| Requestor | [B] |
| r0 | 143744 |
| r1 | 71840 |
| r2 | 143872 |
| r3 | 71936 |
| r4 | 143744 |
| r5 | 143744 |
| r6 | 143872 |
| r7 | 143872 |
| r8 | 50048 |
| r9 | 20096 |
| r10 | 49920 |

The partitioned system runs into problems if the bandwidth requirements are increased further. The memory-aware system however, scales further as the load of the high bandwidth requesters increases. The system simulates properly with a gross load 89.3%, using the scheduling solution shown in Equation 33, while the latency constraints are kept the same.

γ_{bandwidth}=((1; 4; 4); 1) (33)

Subsequently the latency is considered as experienced by the requesters in the simulated models for the two systems in terms of the observed values for the minimum, mean and maximum latency. The measured minimum and maximum values are compared to the theoretical bounds computed by the analytical model. The minimum value is primarily determined by the burst size and the access pattern. The maximum measured latency depends on the arrival process of the interconnect facility, the allocation scheme and the scheduling algorithm. It is interesting to compare this value to the worst-case theoretical bound since this is indicative for the frequency with which the worst-case situation occurs. The mean latency should be kept low since it affects the performance of the system. This value also depends on the arrival process, allocation scheme and the scheduling algorithm.

FIG. 24 shows the above mentioned key figures for the latency observed in a simulated embodiment using partitioning and the request level scheduling. Partitioning the requesters to different banks impacts latency since only one out of n_{banks} bursts is useful to a requestor, regardless of priority level. This means that a low minimum latency cannot be achieved for requests larger than a single burst. As shown in Table 7 many requesters hit the theoretical minimum bound of 260 ns. The maximum measured values come close their theoretical bounds, shown in parenthesis, since partitioning eliminates part of the competition in arbitration. The banks in this particular system have only one reading and one writing requestor, except for bank 1 that also houses the three low latency requesters of the CPU. The figure clearly shows that the requesters partitioned to this bank have significantly increased maximum latency, as indicated by the theoretical bounds. This is also reflected in the increased mean latency. It is also noted that the difference between the mean and maximum value is slightly bigger for these requestors. This reflects that it is not very common for the other requesters in the same direction with equal or higher priority to have their requests available at the same time. It is apparent, as far as flexibility is concerned, that this system does not offer low latency to sensitive requestors. There are two reasons for this. Firstly bursts in the interfering direction causes delays, which is inherent to this design. Secondly, partitioning limits priorities to be significant on a per-bank basis, which causes a high priority requester to come second to low priority requesters partitioned to different banks. This is a limitation of partitioning.

TABLE 7
Minimum, mean and maximum latencies using partitioning and request
level scheduling. Analytical bounds are found in parenthesis.

| Requestor | Min [ns] | Mean [ns] | Max [ns] | |
|---|---|---|---|---|
| r0 | 280.0 (260.0) | 718.8 | 1105.0 | (1105.0) |
| r1 | 260.0 (260.0) | 1048.7 | 2095.0 | (2095.0) |
| r2 | 260.0 (260.0) | 537.8 | 945.0 | (945.0) |
| r3 | 260.0 (260.0) | 767.8 | 2095.0 | (2095.0) |
| r4 | 280.0 (260.0) | 721.2 | 1105.0 | (1105.0) |
| r5 | 305.0 (260.0) | 724.9 | 1105.0 | (1105.0) |
| r6 | 260.0 (260.0) | 539.3 | 945.0 | (945.0) |
| r7 | 260.0 (260.0) | 541 | 945.0 | (945.0) |
| r8 | 260.0 (260.0) | 533 | 945.0 | (1265.0) |
| r9 | 260.0 (260.0) | 766.1 | 1265.0 | (1265.0) |
| r10 | 260.0 (260.0) | 656.5 | 1105.0 | (1105.0) |

Changing the scheduler to work on the burst level instead of the request level resulted in an increase of 12.4% in average latency for r8.

Switching from partitioning to a memory-aware design changes the results considerably, as shown in FIG. 25. A requestor is scheduled for four consecutive bursts at a time. Since a requestor ideally starts right away and is granted four consecutive bursts it follows that the minimum measured latency is lower with this access pattern than in the partitioned system. The maximum measured latency is lower than the theoretical bounds, as shown in Table 8, since not all requesters in the system can have their requests available at the same time on a shared interconnect. The average latency is lower for all requesters compared with the partitioned system. A difference is visible in average latency between high bandwidth and low latency requesters showing that priority levels are useful to diversify the service.

TABLE 8
Minimum, mean and maximum latencies using memory-aware
IP design. Analytical bounds are found in parenthesis.

| Requestor | Min [ns] | Mean [ns] | Max [ns] | |
|---|---|---|---|---|
| r0 | 80.0 (80.0) | 455.5 | 1160.0 | (1655.0) |
| r1 | 80.0 (80.0) | 445.3 | 1125.0 | (1735.0) |
| r2 | 80.0 (80.0) | 454.6 | 1270.0 | (1735.0) |
| r3 | 80.0 (80.0) | 520.3 | 1305.0 | (1815.0) |
| r4 | 80.0 (80.0) | 499.2 | 1205.0 | (1655.0) |
| r5 | 80.0 (80.0) | 429.8 | 1165.0 | (1655.0) |
| r6 | 80.0 (80.0) | 534.9 | 1345.0 | (1735.0) |
| r7 | 80.0 (80.0) | 586.7 | 1405.0 | (1735.0) |
| r8 | 80.0 (80.0) | 354.1 | 985.0 | (1255.0) |
| r9 | 80.0 (80.0) | 360.4 | 1065.0 | (1255.0) |
| r10 | 80.0 (80.0) | 336 | 1085.0 | (1175.0) |

The memory-aware system is clearly capable of delivering lower latency than the partitioned system. In fact, the partitioned system cannot come up with a solution with lower latency than the memory aware system. The potential of the memory-aware system is shown if the optimization criteria are changed to find the solution with the lowest average worst-case latency for low latency requestors. The computed scheduling solution is shown in Equation 34.

γ_{latency=((}1; 2; 2); 3) (34)

This back-end schedule is shorter than the previous one since only one refresh command is included in the refresh group. The basic group consists of two read groups and two write groups, which helps worst-case latency at the expensive of the scheduling efficiency dropping down to 90.0%. Since the number of read groups still equals the number of write groups the mix efficiency remains at 96.5%.

The service period consist of three basic groups, or 112 bursts, and results in an over-allocation of 14.0%. FIG. 26 shows the measured latencies for this embodiment.

The measured and theoretical worst-case latency for the low latency requesters is approximately halved, as shown in Table 9. The tighter bounds of the new solution also affect the average measured latency of the requesters, which is reduced by 30-45%.

The high bandwidth requesters are not considered by the new optimization criteria, resulting in increased theoretical worst-case latency bounds.

TABLE 9
Minimum, mean and maximum latencies using memory-aware
IP design in a latency-optimized system. Analytical
bounds are found in parenthesis.

| Requestor | Min [ns] | Mean [ns] | Max [ns] | |
|---|---|---|---|---|
| r0 | 80.0 (80.0) | 385.4 | 835.0 | (1940.0) |
| r1 | 105.0 (80.0) | 299.5 | 780.0 | (2210.0) |
| r2 | 80.0 (80.0) | 439.3 | 1045.0 | (2210.0) |
| r3 | 80.0 (80.0) | 565.8 | 1125.0 | (2290.0) |
| r4 | 80.0 (80.0) | 340.2 | 865.0 | (1940.0) |
| r5 | 80.0 (80.0) | 277 | 785.0 | (1940.0) |
| r6 | 80.0 (80.0) | 358.5 | 1080.0 | (2210.0) |
| r7 | 80.0 (80.0) | 339.5 | 1235.0 | (2210.0) |
| r8 | 80.0 (80.0) | 195.3 | 445.0 | (540.0) |
| r9 | 80.0 (80.0) | 252.4 | 415.0 | (540.0) |
| r10 | 80.0 (80.0) | 200.3 | 425.0 | (460.0) |

The average-case is further improved by relaxing the requirement that a requestor does not get more than aᵣ bursts in a service period p and by distributing the slack bandwidth in the system. This is realized by letting requestors degrade to best-effort priority when their allocated bursts are served. These requestors are served in FCFS order when no requestors within budget are eligible. This improvement results in a mean reduction of the average measured latency of 2.6%.

According to the present invention the order in which the memory is accessed is defined before the memory is assigned. A dynamical scheduling algorithm selects one of the memory requests provided that it complies with the predefined order. In this way the net bandwidth available to the memory is exactly known. Yet the memory controller is flexible because the predefined memory access options are dynamically scheduled. It is remarked that the scope of protection of the invention is not restricted to the embodiments described herein. Parts of the memory controller may be implemented in hardware, software or a combination thereof. Neither is the scope of protection of the invention restricted by the reference numerals in the claims. The word ‘comprising’ does not exclude other parts than those mentioned in a claim. The word ‘a(n)’ preceding an element does not exclude a plurality of those elements. Means forming part of the invention may both be implemented in the form of dedicated hardware or in the form of a programmed general-purpose processor. The invention resides in each new feature or combination of features

### CITED DOCUMENTS

[1] C. M. Aras et all. “Real-time communication in packet-switched networks.” In Proceedings of the IEEE, volume 82, pages 122-139, January 1994.
[2] A R M. PrimeCell Dynamic Memory Controller (PL340), r0p0 edition, June 2004.
[3] Brahim Bensaou et all. “Credit-based fair queuing (cbfq): a simple service-scheduling algorithm for packet-switched networks. IEEE/ACM Trans. Netw., 9(5):591-604, 2001.
[4] A. Demers et all. “Analysis and simulation of a fair queuing algorithm.” In SIGCOMM '89: Symposium proceedings on Communications architectures & protocols, pages 1-12. ACM Press, 1989.
[5] Santiago Gonzalez Pestana et all. “Cost-performance trade-offs in networks on chip: A simulation-based approach.” In DATE' 04: Proceedings of the conference on Design, Automation and Test in Europe, pages 764-769, February 2004.
[6] Kees Goossens et all. “A design flow for application-specific networks on chip with guaranteed performance to accelerate SOC design and verification. In DATE' 05: Proceedings of the conference on Design, Automation and Test in Europe, pages 1182-1187, Washington, D.C., USA, 2005. IEEE Computer Society.
[7] Francoise Harmsze et all. “Memory arbitration and cache management in stream-based systems.” In DATE, pages 257-262, 2000.
[8] S. Heithecker, A. et all. “A mixed QoS SDRAM controller for FPGA-based high-end image processing. In IEEE Workshop on Signal Processing Systems, pages 322-327. IEEE, August 2003.
[9] JEDEC Solid State Technology Association, JEDEC Solid State Technology Association 2004, 2500 Wilson Boulevard, Arlington, Va. 22201-3834. DDR2 SDRAM Specification, jesd79-2a edition, January 2004.
[10] Tzu-Chieh Lin et all. “Quality-aware memory controller for multimedia platform soc. In IEEE Workshop on Signal Processing Systems, SIPS 2003, pages 328-333, August 2003.
[11] John B. Nagle. “On packet switches with infinite storage.” IEEE Transactions on Communications, COM-35(4):435{438, April 1987.
[12] Clara Otero Perez et all. “Resource reservations in shared-memory multiprocessor SOCs.” In Peter van der Stok, editor, Dynamic and Robust Streaming In And Between Connected Consumer-Electronics Devices. Kluwer, 2005.
[13] Abhay K. Parekh and Robert G. Gallager. “A generalized processor sharing approach to flow control in integrated services networks: the single-node case. IEEE/ACM Trans. Netw., 1(3):344-357, 1993.
[14] E. Rijpkema, et all. “Trade offs in the design of a router with both guaranteed and best-effort services for networks on chip. IEEE Proceedings: Computers and Digital Technique, 150(5):294-302, September 2003.
[15] Scott Rixner et. All “Memory access scheduling. “In ISCA '00: Proceedings of the 27th annual international symposium on Computer architecture, pages 128-138. ACM Press, 2000.
[16] M. Shreedhar and George Varghese. Efficient fair queuing using deficit round robin. In SIGCOMM, pages 231-242, 1995.
[17] Wolf-Dietrich Weber. “Efficient Shared DRAM Subsystems for SOCs.” Sonics, Inc, 2001.
[18] Hui Zhang. “Service disciplines for guaranteed performance service in packet-switching networks.” Proceedings of the IEEE, 83(10):1374-96, October 1995.
[19] Hui Zhang and Srinivasan Keshav. “Comparison of rate-based service disciplines.” In SIGCOMM '91: Proceedings of the conference on Communications architecture & protocols, pages 113-121. ACM Press, 1991.

1. A method for controlling access of a plurality of requesters to a shared memory during a time window comprising:
receiving access requests from various requestors; determining a type of access requested by the requests; comparing the requested access type with an access type authorized for said time-window according to a back-end schedule; generating a first selection of the incoming requests which have the prescribed access type for the said time-window; dynamically selecting one of the requests from the first selection.

2. A memory controller for controlling access of a plurality of requesters to a shared memory, the memory controller comprising, an input for receiving requests for access to the memory from the plurality of requestors, an arbitrator for dynamically granting one of the requests in accordance with a predetermined back end schedule comprising a sequence of basic groups.

3. A memory controller according to claim 2, wherein the memory has at least two memory banks, and wherein the back end schedule provides separate time windows for access of the different banks in an interleaved fashion.

4. A memory controller according to claim 2, wherein the back end schedule is fixed.

5. A memory controller according to claim 2, comprising a facility for allowing a user to program the back end schedule.

6. A memory controller according to claim 2, wherein the scheduler has a facility for dynamically updating the back end schedule.

7. (canceled)
